(19) United States
(12) Patent Application Publication
(10) Pub. No.: US 2026/0364590 A1
(43) Pub. Date: Nov. 19, 2026

(54) PIPETTE CONTROLLER AND A METHOD OF DETERMINING A PIPETTE SIZE OF A PIPETTE OF A PIPETTE CONTROLLER

(71) Applicant: Vistalab Technologies, LLC, Patterson, NY (US)

(72) Inventors: Alexander Javier Sosa, Brewster, NY (US); Matthew Christopher Franklin, Tyngsborough, MA (US); Devon Daniel Brown, Bedford Hills, NY (US)

(21) Appl. No.: 19/676,536

(22) Filed: May 13, 2026

Related U.S. Application Data
(60) Provisional application No. 63/805,190, filed on May 13, 2025.

(51) Int. Cl. B01L 3/02

(52) U.S. Cl. CPC B01L 3/0213; B01L 3/0275; B01L 2200/026; B01L 2200/04; B01L 2200/146; B01L 2300/027; B01L 2300/0663; B01L 2300/0832; B01L 2400/049; B01L 2400/0622

(57) ABSTRACT

A pipette controller includes a nozzle assembly, a pipette, nozzle assembly, a pressure tank, a pump configured to create positive air pressure inside the pressure tank, an aliquot valve controlling airflow between the pressure tank and the nozzle assembly, and an electronic controller. The electronic controller controls the aliquot valve to dispense a volume of liquid equal to a set aliquot volume from the pipette via an amount of air transferred from the pressure tank to the nozzle assembly and to determine a pipette size based on a pressure drop of an air pressure within the pipette. The pipette controller also determines the pipette size via a pipette size determination routine in which a predetermined volume of air is removed from the pipette and a resulting pressure change is compared to predetermined ranges corresponding to a plurality of pipette sizes.

### CROSS REFERENCE TO RELATED APPLICATIONS

This application claims the benefit of priority of U.S. Provisional Patent Application No. 63/805,190, filed on May 13, 2025, the contents of which is hereby incorporated by reference in its entirety.

### TECHNICAL FIELD

The present disclosure relates generally to pipette controllers and methods of determining pipette sizes of pipettes removably coupled to pipette controllers.

### BACKGROUND

Pipette controllers generally provide for aspirating liquid into a pipette and dispensing of aliquots of liquid from the pipette. Pipette controllers are commonly utilized in laboratory settings for liquid measurement and dispensing to perform various scientific tasks, such as drug development, environmental testing, and diagnostic testing.

### BRIEF DESCRIPTION OF THE DRAWINGS

Features and advantages will be apparent from the following, more particular, description of various exemplary embodiments, as illustrated in the accompanying drawings, wherein like reference numbers generally indicate identical, functionally similar, or structurally similar elements.

FIG. 1 is an elevational view of an exemplary pipette controller, according to the present disclosure.

FIG. 2 is a cutaway view of the pipette controller of FIG. 1.

FIG. 3 is a cutaway view of the pipette controller taken at detail “3” in FIG. 1.

FIGS. 4 and 5 are schematic diagrams of components of the pipette controller of FIGS. 1 to 3.

FIG. 6 is a block diagram of electrical components of the pipette controller of FIGS. 1 to 5.

FIGS. 7A and 7B are flowcharts depicting an exemplary aliquot dispense mode of the pipette controller of FIGS. 1 to 6, according to the present disclosure.

FIG. 8 is a schematic diagram of serological pipette pressures.

FIG. 9 is a schematic diagram of a serological pipette disposed vertically and

disposed at an angle.

FIG. 10 represents, in graph form, a nozzle pressure drop as a function of a set aliquot volume, according to the present disclosure.

FIG. 11 is detail view of measurements taken at detail “11” in FIG. 10.

FIG. 12 represents, in graph form, a nozzle pressure drop as a function of a set aliquot volume, according to the present disclosure.

FIG. 13 is detail view of measurements taken at detail “13” in FIG. 12.

FIG. 14 is a flowchart depicting another exemplary aliquot dispense mode of the pipette controller of FIGS. 1 to 6, according to the present disclosure.

FIG. 15 is a flowchart depicting an exemplary method of determining a pipette size of a pipette coupled to a pipette controller, such as the pipette controller of FIGS. 1 to 6, according to the present disclosure.

FIG. 16 is a flowchart depicting another exemplary method of determining a pipette size of a pipette coupled to a pipette controller, such as the pipette controller of FIGS. 1 to 6, according to the present disclosure.

FIG. 17 is a flowchart depicting an exemplary method of determining a pipette size of a pipette coupled to a pipette controller using a pipette size determination routine, such as the pipette controller of FIGS. 1 to 6, according to the present disclosure.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the spirit and the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the present disclosure.

Although the term “pipette” and “pipette controller” may be used to describe embodiments of the present disclosure, a person skilled in the relevant art will recognize that other devices that aspirate liquids may be used without departing from the spirit and the scope of the present disclosure.

As used herein, the terms “first,” “second,” “third,” etc., may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially” is not to be limited to the precise value specified. In at least some instances, the approximating language may correspond to the precision of an instrument for measuring the value, or the precision of the methods or the machines for constructing or manufacturing the components, the systems, or both. For example, the approximating language may refer to being within a one percent (1%) margin, a two percent (2%) margin, a four percent (4%) margin, a ten percent (10%) margin, a fifteen percent (15%) margin, or a twenty percent (20%) margin in either individual values, range(s) of values and/or endpoints defining range(s) of values.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

In some embodiments, aspects of the present disclosure, including computerized implementations of methods or of processes according to the present disclosure, can be implemented as a system, a method, an apparatus, or an article of manufacture using standard programming or engineering techniques to produce software, firmware, hardware, or any combination thereof to control a processor device (e.g., a serial or parallel general-purpose or specialized processor chip, a single- or multi-core chip, a microprocessor, a field programmable gate array, any variety of combinations of a control unit, an arithmetic logic unit, and a processor register, and so on), a computer (e.g., a processor device operatively coupled to a memory), or another electronically operated controller to implement aspects detailed herein. Accordingly, for example, implementations of embodiments of the present disclosure can be implemented as a set of instructions, tangibly embodied on a non-transitory computer-readable media, such that a processor device can implement the instructions based upon reading the instructions from the computer-readable media. In some such embodiments, a computer-readable medium may contain instructions that, when executed by a processor, cause the processor to carry out all or portions of the methods and the processes described herein. Some embodiments of the present disclosure can include (or utilize) a control device such as an automation device, a special purpose or a general-purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., a memory, a communication system, a power source, a user interface, and other inputs, etc.).

The term “article of manufacture,” as used herein, is intended to encompass a computer program accessible from any computer-readable device, carrier (e.g., non-transitory signals), or media (e.g., non-transitory media). For example, computer-readable media can include but are not limited to magnetic storage devices (e.g., a hard disk, a floppy disk, a magnetic strip, and so on), optical disks (e.g., a compact disk (CD), a digital versatile disk (DVD), and so on), smart cards, and flash memory devices (e.g., a card, a stick, and so on). Additionally, a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the spirit and the scope of the present disclosure.

Certain operations of methods according to the present disclosure, or of systems executing those methods, may be represented schematically in the Figures, or otherwise discussed herein. Unless otherwise specified or limited, representation in the Figures of particular operations in a particular spatial order may not necessarily require those operations to be executed in a particular sequence corresponding to the particular spatial order. Correspondingly, certain operations represented in the Figures, or otherwise disclosed herein, can be executed in different orders than are expressly illustrated or described, as appropriate for particular embodiments of the present disclosure. Further, in some examples, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” and the like, are intended to encompass part or all of computer-related systems that include hardware, software, or a combination of hardware and software. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or a system, a module, and so on) may reside within a process or thread of execution, may be localized on one computer, may be distributed between two or more computers or other processor devices, or may be included within another component (or a system, a module, and so on).

Serological pipettes are widely used for liquid measurement and dispensing in laboratory settings. Depending on a particular application, such pipettes may be formed of various materials, e.g., glass or plastic, and may be provided in various sizes, e.g., one (1) milliliter (ml) to one hundred (100) ml, with graduations printed on them. Traditionally, liquid was drawn into such pipettes by applying suction to the top end thereof by a rubber bulb, measured by aspirating to a graduation line, and then dispensed by removing the suction. Current practice often utilizes a pipette controller, which uses a small, battery-powered air pump and trigger-style pneumatic valves to manipulate pressure inside of serological pipettes to draw up and then to expel a liquid therefrom.

Frequently, multiple aliquots of a liquid sample must be dispensed for analytical processes. To do this, a user first aspirates slightly more than the required volume and then slowly dispenses the sample until the meniscus of the liquid aligns with a graduation line on the serological pipette to achieve a starting volume. The user must note the starting volume and then dispense liquid until the meniscus drops to the graduation line corresponding to the difference between the starting volume and the desired dispense volume. If another aliquot is required, the user dispenses again to the graduation line corresponding to the difference between the prior reading and the desired volume. This methodology is, however, a time consuming and fatiguing process, especially, when this process must be repeated many times. In addition, this process introduces multiple sources of error.

Some conventional pipette controllers utilize one or more pressure tanks to overcome some of the described above issues and to provide a more user friendly and accurate pipette controller. In such conventional pipette controllers there is, however, commonly no way to determine a particular pipette size of a pipette that is removably coupled to the pipette controller and a user may over-aspirate liquid into the pipette, which can cause damage to the pipette controller. Some conventional pipette controllers assume a standard pipette size, which may provide accuracy and precision of the pipette controller to a certain degree, but that could be improved upon if multiple profiles for differing pipette sizes could be utilized. Further, some conventional pipette controllers may be capable of determining a pipette size only if specialized pipets are utilized with the particular pipette controller.

Accordingly, the present disclosure provides for a pipette controller that can determine a particular pipette size of a pipette coupled to the pipette controller based on a nozzle pressure drop within the pipette after a set aliquot volume is dispensed from the pipette. Particularly, embodiments of the present disclosure utilize a nozzle pressure sensor built into a pipette controller to measure a change in static pressure before and after dispensing a known volume of liquid from the pipette. This equates to the change in the height of the liquid column for a given volume and therefor deduces the diameter (corresponding to volume capacity) of the installed pipette. Thus, embodiments of the present disclosure can provide for automatic aliquoting and aspirating of the pipette controller, as well as automatic filling of the pipette (e.g., to a maximum volume of the particular pipette) for subsequent repeat aliquoting. Embodiments of the present disclosure can prevent over-aspiration of liquid into the pipette controller thereby increasing reliability. Embodiments of the present disclosure can also improve the accuracy and precision of the dispensed volumes from the pipette controller by compensating for the pipette size (e.g., a pipette diameter).

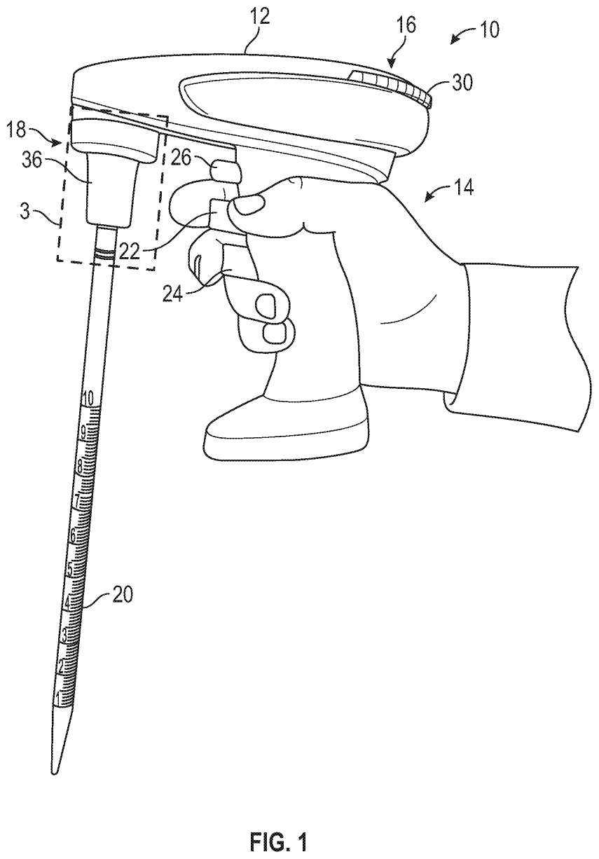

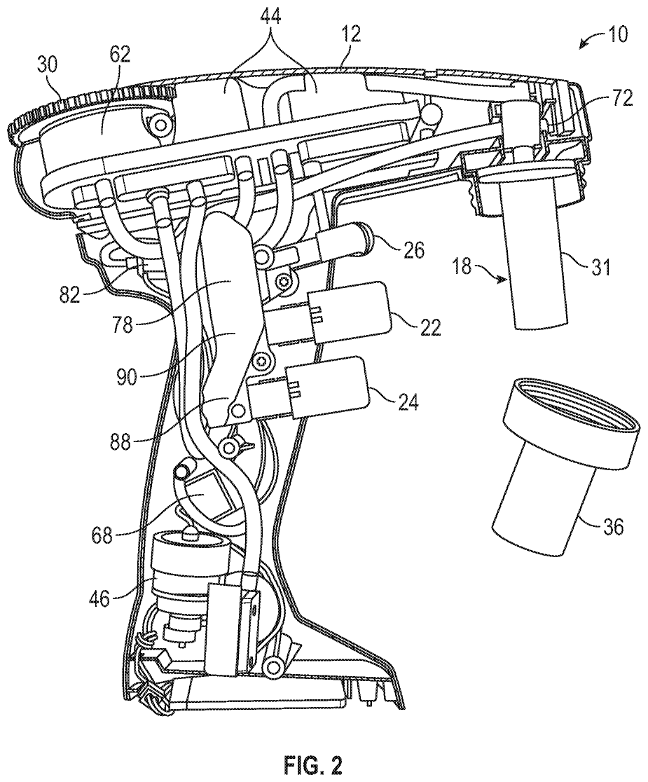

Referring now to the drawings, FIG. 1 is an elevational view of an exemplary pipette controller 10, according to an embodiment of the present disclosure. FIG. 2 is a cutaway view of the pipette controller 10 of FIG. 1. As shown in FIGS. 1 and 2, the pipette controller 10 includes a housing 12 with a lower housing portion 14 and an upper housing portion 16 extending from the lower housing portion 14. The lower housing portion 14 is configured to be grasped in a palm of a hand of a user in order to operate the pipette controller 10. A nozzle assembly 18 extends from a distal end of the upper housing portion 16. The nozzle assembly 18 is configured to removably couple a serological pipette 20 to the pipette controller 10. As will be discussed in greater detail below with reference to FIGS. 2A and 2B, when the pipette 20 is removably received by the nozzle assembly 18, the pipette 20 is pneumatically connected to the pipette controller 10 via a cone seal 31 (FIG. 2) of the nozzle assembly 18. The pipette 20 may be removed or decoupled from nozzle assembly 18 by engaging a portion of the nozzle assembly 18, such as a cover 36 (FIG. 2) that engages the cone seal 31 (FIG. 2). As such, a user of the pipette controller 10 may quickly remove and replace the pipette 20, via the nozzle assembly 18, with another pipette having one or more different characteristics.

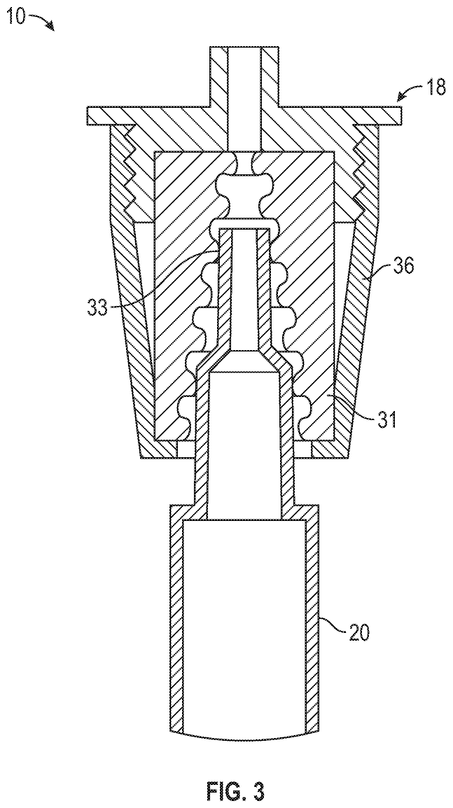

FIG. 3 is a cutaway view of the pipette controller 10 at detail “3” in FIG. 1. As shown in FIG. 3, a pipette tip 33 of the pipette 20 is received within the cone seal 31 of the nozzle assembly 18. The cover 36 of the nozzle assembly 18 secures the pipette tip 33 within the cone seal 31. In the illustrated embodiment, the nozzle assembly 18 of the pipette controller 10 is configured to removably receive a plurality of pipettes, including the pipette 20. The plurality of pipettes vary in size (e.g., a volumetric size or diameter), but each generally has a pipette tip that is of similar dimensions and shape as the pipette tip 33 of the pipette 20. In some embodiments, the pipette controller 10 is configured to receive a plurality of pipettes having pipette sizes including a five (5) ml pipette, a ten (10) ml pipette, a twenty-five (25) ml pipette, a fifty (50) ml pipette, and a one hundred (100) ml pipette.

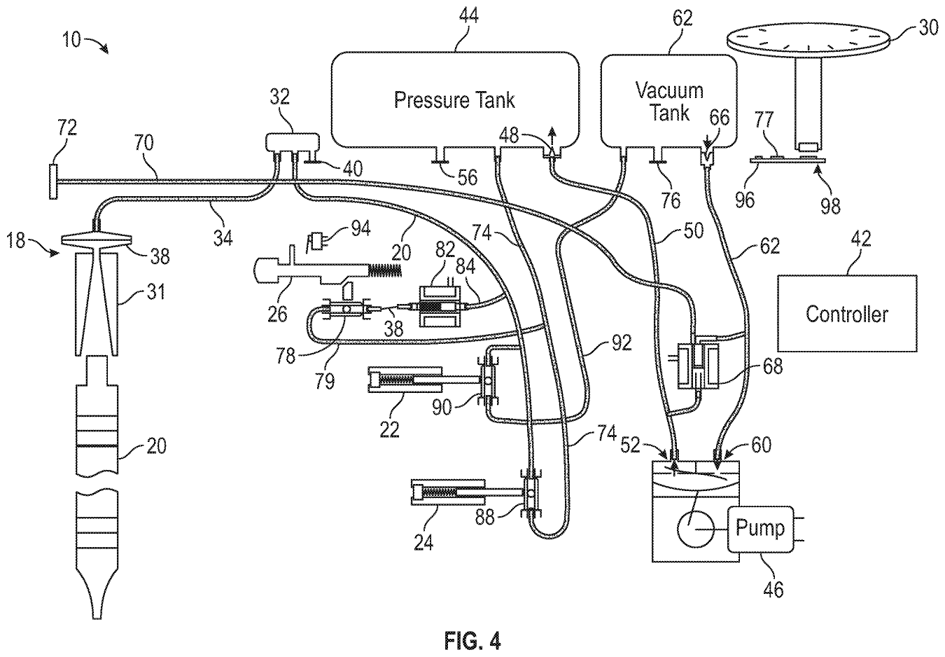

Referring again to FIGS. 1 and 2, an aspirate actuator 22, a dispense actuator 24, and an aliquot actuator 26 extend from the lower housing portion 14 and are configured to be engageable by one or more fingers of the user during operation of the pipette controller 10. As will be discussed in greater detail below with reference to FIGS. 4 and 5, the pipette controller 10 aspirates a volume of a liquid into the pipette 20 when the user depresses aspirate actuator 22 and dispenses liquid from the pipette 20 when the user depresses dispense actuator 24. The aliquot actuator 26 enables dispensing of precise aliquots of liquid from the pipette 20. Particularly, each depression of the aliquot actuator 26 causes the pipette controller 10 to dispel an equal, measured volume of liquid from the pipette 20, e.g., that is set by an aliquot volume control interface 30. Although the aspirate actuator 22, the dispense actuator 24, and the aliquot actuator 26 are depicted as buttons in the illustrated embodiment of FIGS. 1 and 2, the aspirate actuator 22, the dispense actuator 24, and the aliquot actuator 26 may be any type of user interface that is engageable by a user. For example, in some embodiments, one or more of the aspirate actuator 22, the dispense actuator 24, or the aliquot actuator 26 may be touch capacitive sensors configured to receive a user input via contact with a finger of the user.

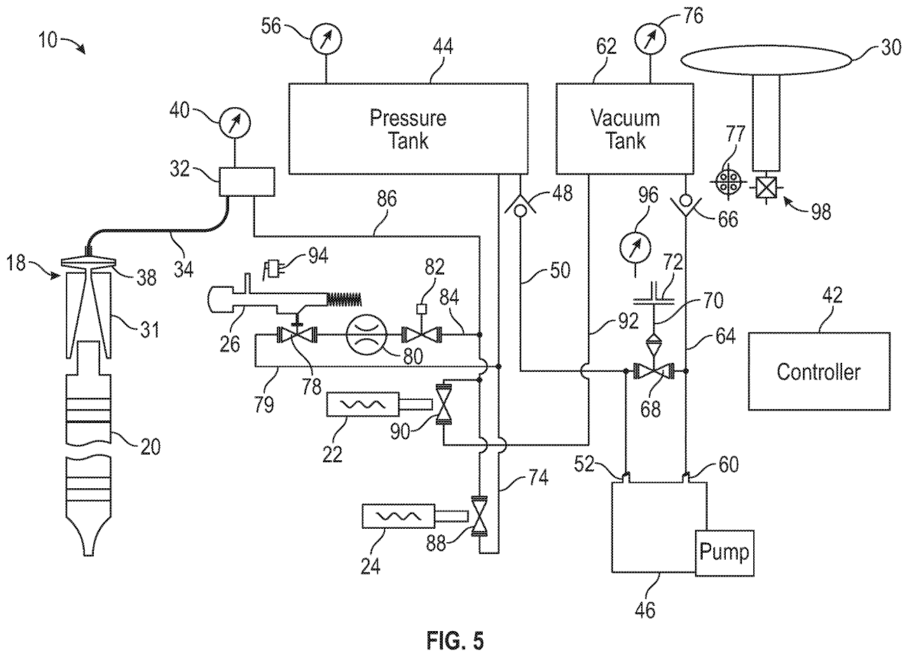

FIGS. 4 and 5 are schematic diagrams of components of the pipette controller 10 of FIGS. 1 and 2. As shown in FIGS. 4 and 5, the pipette controller 10 further includes an electronic controller 42 and a pump 46 that are powered by a power source (not shown). Particularly, the controller 42 is in electrical communication with the aliquot volume control interface 30 and the pump 46 such that the aliquot volume control interface 30 and the pump 46 are powered by the power source (not shown). As will be discussed in more detail below with regard to FIG. 6, the controller 42 is in electrical communication with various other electrical components of the pipette controller 10.

With continued reference to FIGS. 4 and 5, the pipette 20 is removably and pneumatically connected to the cone seal 31 of the nozzle assembly 18, which in turn is connected to a manifold 32 via an air tube 34. In the illustrated embodiment, the nozzle assembly 18 further includes a cover 36 (FIGS. 1 to 3) that removably engages the cone seal 31 and an air filter 38. The air filter 38 is arranged between the air tube 34 and the cone seal 31 and can reduce or prevent debris from entering the air tube 34 or from entering the pipette 20.

With the pipette 20 removably connected to the nozzle assembly 18, the pressure in the manifold 32 is substantially the same pressure in the air column of the pipette 20 (i.e., the space between the liquid and the pipette tip 33 (FIG. 3)). In this way, a nozzle pressure sensor 40 is arranged to sense an air pressure within the manifold 32 (and thus also within the air column within the pipette 20 attached to the nozzle assembly 18). The nozzle pressure sensor 40 is in electrical communication with the controller 42, which is configured to receive signals from the nozzle pressure sensor 40. In some embodiments, the nozzle pressure sensor 40 can be arranged along the air tube 34 between the nozzle assembly 18 and the manifold 32. In some embodiments, the nozzle pressure sensor 40 may be part of the nozzle assembly 18. In some embodiments, the pipette controller 10 may include a plurality of nozzle pressure sensors.

A pressure tank 44 of the pipette controller 10 is in fluid communication with a pump outlet 52 of the pump 46. In this way, the pressure tank 44 is pressurized by the pump 46 through a check valve 48 and an air tube 50 via the pump outlet 52. A pressure tank sensor 56 is arranged to sense a pressure in the pressure tank 44 and is in electrical communication with the controller 42. A pump inlet 60 of the pump 46 is selectively in fluid communication with either a vacuum tank 62 (via an air tube 64 and a check valve 66 (FIG. 2B)) or with atmosphere (via a pump valve 68, an air tube 70, and an air vent 72).

The pressure tank 44 is pneumatically connected to the manifold 32 via an air tube 74, which is connected to an air tube 79. An aliquot enable valve 78, a flow restrictor 80, and an aliquot valve 82 are disposed along the air tube 79. An air tube 84 connects the aliquot valve 82 to an air tube 86, which is connected to the manifold 32. The pressure tank 44 is also pneumatically connected to the manifold 32 through the air tube 74, a dispense valve 88, and the air tube 86. The pump valve 68 connects the air vent 72, via the air tube 70, to either the pump inlet 60 or the pump outlet 52 of the pump 46. In the illustrated embodiment, the pump valve 68 is a three-way solenoid actuated valve in electrical communication with the controller 42. In this way, the controller 42 is configured to selectively control the pump valve 68.

The vacuum tank 62 is pneumatically connected to the manifold 32 via an air tube 92, an aspirate valve 90, and the air tube 86. In the illustrated embodiment, a vacuum tank sensor 76 is arranged to sense a pressure within the vacuum tank 62 and is in electrical communication with the controller 42.

In the illustrated embodiment, the aliquot valve 82 is a normally open solenoid actuated ball valve that is in electrical communication with the controller 42. In this way, the controller 42 is configured to move the aliquot valve 82 from an open position, in which the aliquot valve 82 permits airflow along the air tube 84, to a closed position, in which the aliquot valve 82 prevents airflow along the air tube 84. In other embodiments, the aliquot valve 82 can be any other type of two-way valve.

In some embodiments, two or more air tubes may be joined together in a “T” connection or three-way junction. For example, in some embodiments, where the air tube 84 joins the air tube 86, three paths may be joined pneumatically. In some embodiments, the three-way junction may be formed by plastic fittings (shaped like a “T”) that have three nipples, each of which is connected to a respective air tube.

The aspirate actuator 22 and the dispense actuator 24 control the aspirate valve 90 and the dispense valve 88, respectively. Particularly, in the illustrated embodiment, the aspirate valve 90 and the dispense valve 88 are normally closed ball valves that are opened by depressing the aspirate actuator 22 and the dispense actuator 24, respectively. A degree of opening of the aspirate valve 90 and the dispense valve 88 may be varied with the amount of pressure applied by the user to the aspirate actuator 22 and to the dispense actuator 24, respectively. An aliquot switch 94 is arranged to detect actuation of the aliquot actuator 26 and is in electrical communication with the controller 42. In this way, the controller 42 is configured to receive signals from the aliquot switch 94, which indicate actuation of the aliquot actuator 26.

An atmospheric pressure sensor 96 is arranged within the housing 12 (FIGS. 1 and 2) to sense an atmospheric pressure external to the pipette controller 10 and is in electrical communication with the controller 42. An interface sensor 98 is configured to measure a position of the aliquot volume control interface 30 and is in electrical communication with the controller 42. In the illustrated embodiment, the aliquot volume control interface 30 is a dial that is rotated by the user to align an indicator with preset volume markings and the interface sensor 98 may be a Hall Effect sensor.

In some embodiments, the aliquot volume control interface 30 may be operable by the user to switch between two or more operating modes of the pipette controller 10. In some embodiments, the aliquot volume control interface 30 may include one or more aliquot control buttons (not shown) operable by a user to adjust a set aliquot volume of the pipette controller 10. In some embodiments, the aliquot volume control interface 30 may include a display screen (e.g., a liquid-crystal display (LCD), an electronic paper (E-ink) display, among others) to display one or more operational parameters of the pipette controller 10. For example, in some embodiments, the display screen may display the set aliquot volume, a currently selected operating mode of the pipette controller 10, a battery percentage of a power source (not shown) of the pipette controller 10, among others.

In some embodiments, the pipette controller 10 may be configured to connect to a user's mobile device (e.g., a mobile phone, a smartwatch, etc.) and the aliquot volume control interface 30 can be provided on the user's mobile device. In some embodiments, the pipette controller 10 may further include one or more visual, audio, or haptic indicators that are configured to indicate one or more operational parameters to the user. For example, in some embodiments, a user indicator may be disposed within the lower housing portion 14 of the housing 12 that may cause vibrations to the user's hand to indicate to the user that the pipette controller 10 is ready for a subsequent aliquot dispense.

For illustrative purposes, electrical connections (e.g., via electrical wiring) between various electronic components and the controller 42 are not shown in FIGS. 4 and 5. In this regard, FIG. 6 is a block diagram of electrical components of the pipette controller 10. As shown in FIG. 6, the controller 42 is in electrical communication with each of the nozzle pressure sensor 40, the pressure tank sensor 56, the vacuum tank sensor 76, an orientation sensor 77, the atmospheric pressure sensor 96, and the interface sensor 98, e.g., via an inter-integrated circuit (i.e., an I2C bus). Further, the controller 42 is in electrical communication with (e.g., sends control signals to) the pump 46, the pump valve 68, and the aliquot valve 82. The controller 42 is in electrical communication with (e.g., receives signals from) the aliquot switch 94.

The pipette controller 10 is configured to operate in either a manual aspirate and dispense mode, in which the user manually aspirates liquid into the pipette 20 via the aspirate actuator 22 and manually dispenses liquid from the pipette 20 via the dispense actuator 24, or an aliquot dispense mode, in which precise aliquots of liquid are dispensed from the pipette 20 with each actuation of the aliquot actuator 26.

Manual Aspirate and Dispense Mode. With the pipette controller 10 operating in the manual aspirate and dispense mode, liquid may be aspirated and dispensed from the pipette 20 by actuating the aspirate actuator 22 and the dispense actuator 24, respectively. The pump 46 may be controlled by the controller 42, and may be operated such that the pressure tank 44 and the vacuum tank 62 are set to a known pressure, for example, three (3) psi and negative three (−3) psi, respectively. According to an embodiment, the known pressure ranges for the pressure tank 44 and the vacuum tank 62 may be, for example ten (10) psi and negative ten (−10) psi, respectively. When the pressure tank 44 is being pressurized, the pump valve 68, under control of the controller 42, may connect the air vent 72 through the air tube 70 to the pump inlet 60. In this way, atmospheric air from the air vent 72 is pumped by the pump 46 into the pressure tank 44, while the check valve 66 prevents atmospheric air from entering the vacuum tank 62. The controller 42 is configured to stop operation of the pump 46 when the desired pressure within the pressure tank 44 is achieved. The controller 42 may also vary the rate of pressurization of the pressure tank 44 by modulating power, via a power source (not shown) applied to the pump 46, e.g., via pulse width modulation.

The vacuum tank 62 is evacuated in an analogous way except that the three-way valve 68 connects the air vent 72 to the pump outlet 52 of the pump 46 and this provides the path for air to be evacuated from the vacuum tank 62. The check valve 48 prevents pressurized air from leaking from the pressure tank 44 in this mode of operation.

When the aspirate actuator 22 is actuated, the vacuum from the vacuum tank 62 is applied through the aspirate valve 90 to the manifold 32, and from there to the pipette 20. If the tip of the pipette 20 is immersed in liquid, liquid is thereby sucked into the serological pipette 20. The amount of air through the aspirate valve 90 may be regulated by the pressure on the aspirate actuator 22. Since the vacuum applied from the vacuum tank 62 is applied at or near the instant that the aspirate valve 90 is opened and the pressure is relatively constant, a smooth control over the aspiration rate can be achieved, which is a considerable benefit to the user in comparison to conventional pipette controllers.

To manually dispense liquid from the pipette 20, the dispense actuator 24 is depressed, which connects the pressure tank 44 through the dispense valve 88 to the manifold 32 to the pipette 20. The constant pressure in the pressure tank 44 and operation of the dispense valve 88 provide precise control over the rate of dispensing of liquid from the pipette 20. The controller 42 continually monitors the pressures in the pressure tank 44 and the vacuum tank 62 via the pressure tank sensor 56 and the vacuum tank sensor 76, respectively, and is configured to operate the pump 46 and the pump valve 68 to restore the desired pressure(s) when required. In another embodiment, manual aspirate and dispense of the pipette controller 10 is accomplished by selectively connecting the pump inlet 60 or the pump outlet 52 of the pump 46 to the manifold 32 in order to aspirate or dispense liquid, respectively.

Aliquot Dispense Mode. With the pipette controller 10 operating in the aliquot dispense mode, precise aliquots of liquid are dispensed from the pipette 20 with each actuation of the aliquot actuator 26. For example, twenty (20) ml of liquid may first be aspirated into the pipette 20 by actuating the aspirate actuator 22 until the required total liquid level is observed in the pipette 20. The desired aliquot volume is set using the aliquot volume control interface 30. Then, upon each actuation of the aliquot actuator 26, the desired aliquot volume is dispensed from the pipette 20. In this example, if a one (1) ml aliquot is desired, twenty aliquots of one (1) ml can be dispensed from the pipette 20.

The pipette 20 may be aspirated with a volume greater than the desired aliquot volume by actuation of the aspirate actuator 22 until the desired starting volume is aspirated into the pipette 20. Once the aliquot actuator 26 is actuated by the user, an aliquot of liquid with a volume corresponding to the desired aliquot volume, as set by the aliquot volume control interface 30, is dispensed from the pipette 20. Further aliquots may be dispensed by actuating the aliquot actuator 26 until all of the aspirated liquid is dispensed from the pipette 20.

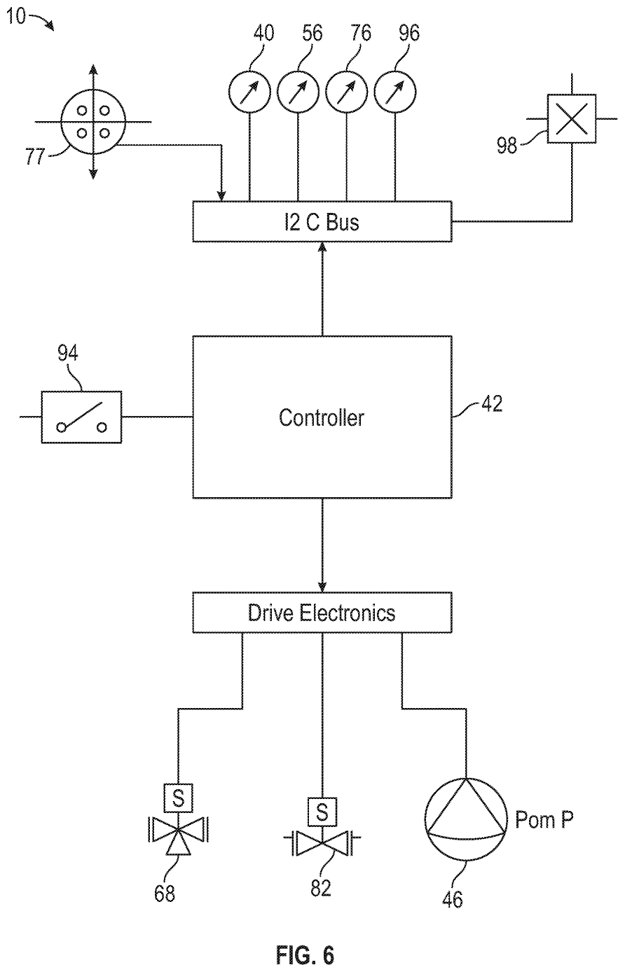

FIGS. 7A and 7B illustrate a flowchart 100 of an exemplary aliquot dispense mode of the pipette controller 10 of FIGS. 1 to 6. As shown in flowchart 100, with the pipette controller 10 operating in the aliquot dispense mode, and when the aliquot actuator 26 is actuated, the aliquot switch 94 is actuated which communicates to the controller 42 that an aliquot is desired. The controller 42 reads the value of the interface sensor 98 which provides the set aliquot volume of the volume of liquid that is to be aliquoted, as indicated by aliquot volume control interface 30. The controller 42 reads the nozzle pressure sensor 40, the pressure tank sensor 56, and the atmospheric pressure sensor 96, which provide the pressures in the manifold 32, pressure tank 44, and the atmosphere, respectively. In some embodiments, the atmospheric pressure sensor 96 may be optional, and atmospheric pressure may be determined by alternate means such as manual input or obtaining pressure readings through the internet. In some embodiments, the pressures measured by the nozzle pressure sensor 40, the pressure tank sensor 56, the vacuum tank sensor 76, and the atmospheric pressure sensor 96 are absolute pressures, however, relative pressure to atmospheric pressure sensors may also be used. In some embodiments, one or more of the nozzle pressure sensor 40, the pressure tank sensor 56, the vacuum tank sensor 76, or the atmospheric pressure sensor 96 may also measure the temperature, and the controller 42 may be further configured to provide corrections due to changes in temperature as well as pressure.

In the illustrated embodiment, the controller 42 is configured to determine the pipette orientation using the orientation sensor 77. The controller 42 then opens the aliquot valve 82 until the pressure in the pressure tank 44 drops by the value that corresponds to the desired volume of liquid to be aliquoted. The algorithm that computes this pressure drop is described below. The air that is released from the pressure tank 44 when the aliquot valve 82 opens is transmitted through the air tube 74, into the air tube 79, through the aliquot enable valve 78, the flow restrictor 80, the aliquot valve 82, the air tube 84, the air tube 86, into the manifold 32, and from there through the air tube 34 to the nozzle assembly 18 and into the pipette 20. According to an embodiment, the aliquot valve 82 is closed when the pressure tank sensor 56 detects that the change in pressure in the pressure tank 44 equals the calculated pressure change from equation (29) or equation (31) described below. The pump 46 then re-pressurizes the pressure tank 44. This process may be repeated for each aliquot. Other types of pressure vessels may be substituted for the pressure tank 44.

Boyle's Law (i.e., PV=nRT) teaches that a container of known volume (V) at a known pressure (P) and temperature (T) will hold a known number of air molecules (n). If the pressure in this volume is reduced a known amount, then a known number of air molecules will be released. According to embodiments, this principle is used to inject a known number of air molecules into a serological pipette (e.g., the pipette 20 of FIG. 1). The relationship between the quantity of air to be injected into the pipette and the set aliquot volume is derived as follows.

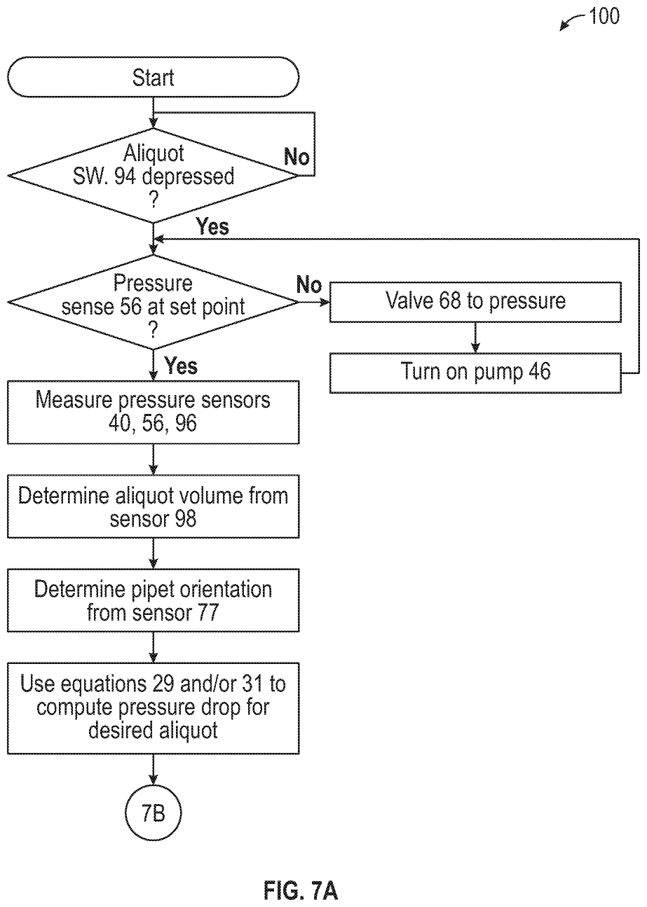

With reference to FIG. 8, Vₚ refers to the total volume of the pipette (e.g., the pipette 20 of FIG. 1). Aₚ refers to the area of the cross-section of the pipette. Pᵢ refers to the initial pressure. Vᵢ refers to the initial volume of liquid within the pipette. P_{d} refers to the injected pressure. V_{d} refers to the injected volume. P_{f} refers to final pressure. V_{f} refers to a final volume of liquid within the pipette. The term hᵢ refers to the initial height of the liquid column within the pipette. The term h_{f} refers to the final height of the liquid column within the pipette. Pₐₜₘ refers to atmospheric pressure.

Assume T is constant, injecting (n) number of air molecules is equivalent to injecting a known volume at a known pressure:

P_{d}V_{d}=nRT. (1)

Total volume of the pipette remains constant:

Vₚ=Vᵢ+hᵢAₚ=V_{f}+h_{f}Aₚ. (2)

Final amount of air in the pipette is equal to initial plus injected. Again, assuming that T is constant:

P_{f}V_{f}=PᵢVᵢ+P_{d}V_{d}. (3)

Pressure in pipette settles out to be atmospheric minus the weight of the water column:

Pᵢ=Pₐₜₘ−ρghᵢ, and (4)

P_{f}=Pₐₜₘ−ρgh_{f}. (5)

Solve equation (2) for V_{f}:

V_{f}=Vᵢ+hᵢAₚ−h_{f}Aₚ. (6)

Substitute P_{f} and Pᵢ from equation (4) and equation (5) into equation (3):

(Pₐₜₘ−ρgh_{f})V_{f}=(Pₐₜₘ−ρghᵢ)Vᵢ+P_{d}V_{d}. (7)

Substitute for V_{f} from equation (6) into equation (7):

(Pₐₜₘ−ρgh_{f})(Vᵢ+hᵢAₚ−h_{f}Aₚ)=(Pₐₜₘ−ρghᵢ)Vᵢ+P_{d}V_{d}, and (8)

PₐₜₘVᵢ+PₐₜₘhᵢAₚ−Pₐₜₘh_{f}Aₚ−ρgh_{f}Vᵢ−ρgh_{f}hᵢAₚ+ρgh_{f}²Aₚ=PₐₜₘVᵢ−ρghᵢVᵢ+P_{d}V_{d}. (9)

Multiply through, solve for zero, factor out h_{f}:

PₐₜₘhᵢAₚ−Pₐₜₘh_{f}Aₚ−ρgh_{f}Vᵢ−ρgh_{f}hᵢAₚ+ρgh_{f}²Aₚ+ρghᵢVᵢ−P_{d}V_{d}=0, and (10)

(ρgAₚ)h_{f}²−(PₐₜₘAₚ+ρgVᵢ+ρghᵢAₚ)h_{f}+(ρghᵢVᵢ−P_{d}V_{d}+PₐₜₘhᵢAₚ)=0. (11)

Plug in coefficients from equation (11) into quadratic formula to solve for h_{f} (the root where the radical is subtracted is the only one that gives a real answer):

$${h}_{f} = \frac{\begin{matrix}( {P}_{a t m} {A}_{p} + ρ g {V}_{i} + ρ {gh}_{i} {A}_{p} ) - \\ \sqrt{\begin{matrix}{( {P}_{a t m} {A}_{p} + ρ g {V}_{i} + ρ g {h}_{i} {A}_{p} )}^{2} - \\ 4 ( ρ g {A}_{p} ) ( ρ g {h}_{i} {V}_{i} - {P}_{d} {V}_{d} + {P}_{a t m} {h}_{i} {A}_{p} )\end{matrix}}\end{matrix}}{( 2 ( ρ g {A}_{p} ) )} . \qquad ( 12 )$$

Volume of water dispensed V_{AQ} is equal to change in water column height times pipette cross-sectional area:

V_{AQ}=(hᵢ−h_{f})Aₚ. (13)

Define ΔP_{N} as gauge pressure in nozzle (above the surface of the liquid) before the dispense:

ΔP_{N}=Pᵢ−Pₐₜₘ. (14)

Solve equation (4) and equation (5) for hᵢ and h_{f} and substitute in equation (14).

$${h}_{i} = ( \frac{{P}_{a t m} - {P}_{i}}{ρ g} ) = \frac{- Δ {P}_{N}}{ρ g} , and \qquad ( 15 )$$

$${h}_{f} = ( \frac{{P}_{a t m} - {P}_{i}}{ρ g} ) - \frac{{V}_{A Q}}{{A}_{P}} = \frac{- Δ {P}_{N}}{ρ g} - \frac{{V}_{A Q}}{{A}_{P}} . \qquad ( 16 )$$

Solve equation (10) for P_{d}V_{d}:

P_{d}V_{d}=PₐₜₘhᵢAₚ−Pₐₜₘh_{f}Aₚ−ρgh_{f}Vᵢ−ρgh_{f}hᵢAₚ+ρgh_{f}²Aₚ+ρghᵢVᵢ. (17)

Substitute equation (15) and equation (16) into equation (17):

$${P}_{d} {V}_{d} = {P}_{atm} \frac{- Δ {P}_{N}}{ρ g} {A}_{p} - {P}_{atm} ( \frac{- Δ {P}_{N}}{ρ g} - \frac{{V}_{A Q}}{{A}_{P}} ) {A}_{p} - ρ g ( \frac{- Δ {P}_{N}}{ρ g} - \frac{{V}_{A Q}}{{A}_{P}} ) {V}_{i} - ρ g ( \frac{- Δ {P}_{N}}{ρ g} - \frac{{V}_{AQ}}{{A}_{P}} ) \frac{- Δ {P}_{N}}{ρ g} {A}_{p} + ρ {g ( \frac{- Δ {P}_{N}}{ρ g} - \frac{{V}_{AQ}}{AP} )}^{2} {A}_{p} + ρ g \frac{- Δ {P}_{N}}{ρ g} {V}_{i} , \qquad ( 18 )$$

$${P}_{d} {V}_{d} = {P}_{atm} \frac{Δ {P}_{N}}{ρ g} {A}_{p} - {P}_{atm} \frac{Δ {P}_{N}}{ρ g} {A}_{p} + {P}_{atm} \frac{{V}_{A Q}}{{A}_{P}} {A}_{p} + ρ g \frac{Δ {P}_{N}}{ρ g} {V}_{i} + ρ g \frac{{V}_{A Q}}{{A}_{P}} {V}_{i} - \frac{Δ {P}_{N}}{ρ g} Δ {P}_{N} {A}_{p} - \frac{{V}_{A Q}}{{A}_{P}} Δ {P}_{N} {A}_{p} + ρ {g ( \frac{- Δ {P}_{N}}{ρ g} )}^{2} {A}_{p} + 2 ρ g \frac{Δ {P}_{N}}{ρ g} \frac{{V}_{A Q}}{{A}_{P}} {A}_{p} + ρ {g ( \frac{{V}_{A Q}}{{A}_{P}} )}^{2} {A}_{p} - Δ {P}_{N} {V}_{i} , and \qquad ( 19 )$$

$${P}_{d} {V}_{d} = {P}_{atm} {V}_{A Q} + Δ {P}_{N} {V}_{i} + ρ g \frac{{V}_{A Q}}{{A}_{P}} {V}_{i} - \frac{Δ {P}_{N}^{2}}{ρ g} {A}_{p} - {V}_{A Q} Δ {P}_{N} + \frac{Δ {P}_{N}^{2}}{ρ g} {A}_{p} + 2 Δ {P}_{N} {V}_{A Q} + ρ g \frac{{V}_{AQ}^{2}}{{A}_{P}} - Δ {P}_{N} {V}_{i} . \qquad ( 20 )$$

Multiply through, and simplify a few times:

$${P}_{d} {V}_{d} = {P}_{atm} {V}_{A Q} + ρ g \frac{{V}_{A Q}}{{A}_{P}} {V}_{i} + Δ {P}_{N} {V}_{A Q} + ρ g \frac{{V}_{AQ}^{2}}{{A}_{P}} . \qquad ( 21 )$$

Solve equation (2) for Vᵢ and substitute in equation (15):

$${V}_{i} = {V}_{p} - {h}_{i} {A}_{p} = {V}_{p} + \frac{Δ {P}_{N}}{ρ g} {A}_{p} . \qquad ( 22 )$$

Substitute equation (22) into equation (21):

$${P}_{d} {V}_{d} = {P}_{atm} {V}_{A Q} + ρ g \frac{{V}_{A Q}}{{A}_{P}} ( {V}_{p} + \frac{Δ {P}_{N}}{ρ g} {A}_{p} ) + Δ {P}_{N} {V}_{A Q} + ρ g \frac{{V}_{AQ}^{2}}{{A}_{P}} . \qquad ( 23 )$$

Multiply through and simplify:

$${P}_{d} {V}_{d} = {P}_{atm} {V}_{A Q} + ρ g \frac{{V}_{A Q}}{{A}_{P}} {V}_{p} + ρ g \frac{{V}_{A Q}}{{A}_{P}} \frac{Δ {P}_{N}}{ρ g} {A}_{P} + Δ {P}_{N} {V}_{A Q} + ρ g \frac{{V}_{AQ}^{2}}{{A}_{P}} , and \qquad ( 24 )$$

$${P}_{d} {V}_{d} = {P}_{atm} {V}_{A Q} + ρ g \frac{{V}_{A Q}}{{A}_{P}} {V}_{p} + 2 Δ {P}_{N} {V}_{A Q} + ρ g \frac{{V}_{AQ}^{2}}{{A}_{P}} . \qquad ( 25 )$$

Factor out desired dispense volume:

$${P}_{d} {V}_{d} = {V}_{A Q} ( {P}_{atm} + ρ g \frac{{V}_{P}}{{A}_{P}} + 2 Δ {P}_{N} + ρ g \frac{{V}_{A Q}}{{A}_{P}} ) . \qquad ( 26 )$$

Simplify:

$${P}_{d} {V}_{d} = {V}_{A Q} ( {P}_{atm} + 2 Δ {P}_{N} + ρ g \frac{( {V}_{P} + {V}_{A Q} )}{{A}_{P}} ) . \qquad ( 27 )$$

Solve equation (26) for Pa:

$${P}_{d} = \frac{{V}_{A Q}}{{V}_{d}} ( {P}_{atm} + 2 Δ {P}_{N} + ρ g \frac{( {V}_{P} + {V}_{A Q} )}{{A}_{P}} ) . \qquad ( 28 )$$

When V_{d} is taken to be the volume of the pressure tank (e.g., the pressure tank 44 of the pipette controller 10 in FIGS. 4 and 5), P_{d} would be the required drop in the pressure tank pressure to dispense V_{AQ} of liquid given assumptions about the cross-sectional area Aₚ and the volume Vₚ of the pipettes and going off of the nozzle gauge pressure ΔP_{N}, also assuming water density, and generally isothermal conditions, and an entirely cylindrical pipette. Vₚ should include the dead volume inside the controller air path, so replace Vₚ with Vₚ+V_{dv}:

$${P}_{d} = \frac{{V}_{A Q}}{{V}_{d}} ( {P}_{atm} + 2 Δ {P}_{N} + ρ g \frac{( {V}_{P} + {V}_{d v} + {V}_{A Q} )}{{A}_{P}} ) . \qquad ( 29 )$$

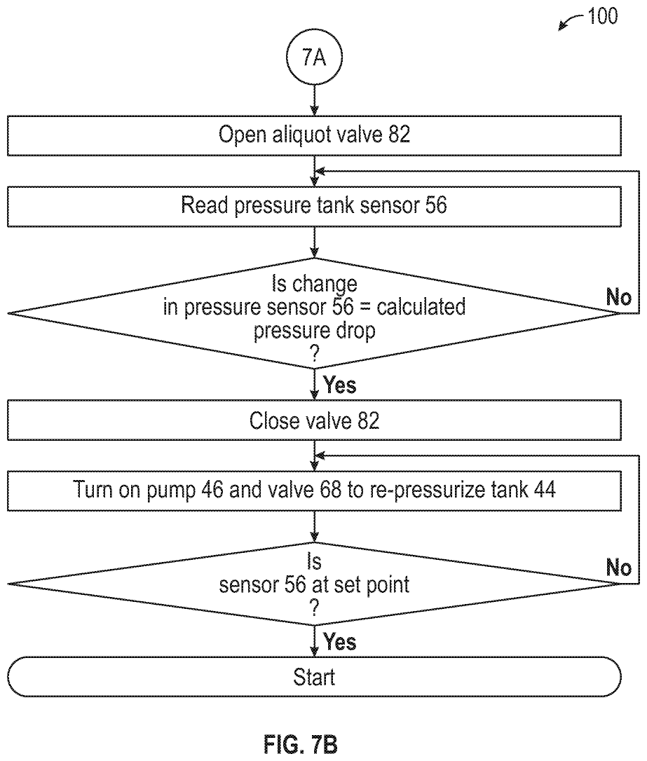

Referring to FIG. 9, according to embodiments, an orientation of a pipette (e.g., the pipette 20 of FIG. 1) may be determined. For example, with reference to the pipette controller 10 of FIGS. 1 to 6, the orientation of pipette 20 may be determined by the controller 42 using the orientation sensor 77 of the pipette controller 10. In the event that the pipette is held at an angle θ instead of vertically, the volume terms in equation (29) will remain the same since volume is independent of orientation. The Aₚ term is, however, affected, since the area of the water in the pipette that the air pressure now has an effect on is a larger oval rather than the original circle that is present when the pipette is held vertically:

$${A}_{a n g} = \frac{{A}_{vert}}{cos ( Θ )} . \qquad ( 30 )$$

One way to solve for the change in the Aₚ term is to take advantage of the fact that the volume of water is independent of θ:

V_{w}=Aᵥₑᵣₜh_{WCvert}=A_{ang}h_{WCang}=A_{ang}(h_{WCvert} cos(θ)). (31)

The product of the area of the pipette when the pipette is vertical and the height of the water column when the pipette is vertical (h_{WCvert}) is equal to the product of the area of the pipette when the pipette is angled and the height of the water column when the pipette is angled (h_{WCang}). Given the geometry of the arrangement, the height of the water column when it is angled is cos(θ) times the height of the vertical water column, so solving for the area of the angled pipette results in equation (30).

Substituting this definition of the area of the pipette that accounts for the angle back into equation (29) provides:

$${P}_{d} = \frac{{V}_{A Q}}{{V}_{d}} ( {P}_{atm} + 2 Δ {P}_{N} + ρ g \frac{( {V}_{P} + {V}_{d v} + {V}_{A Q} )}{\frac{{A}_{P}}{cos ( Θ )}} ) . \qquad ( 32 )$$

Based on the derivation above, the pressure drop P_{d} required to achieve the set aliquot volume V_{AQ} can be computed (e.g., by the controller 42 of the pipette controller 10) using this equation. Note that the dead volume V_{dv} in the pipette controller is small relative to the pipette volume Vₚ, and that the set aliquot volume V_{AQ} is also usually small relative to the pipette volume Vₚ. Therefore, the term (Vₚ+V_{dv}+V_{AQ})/Aₚ is approximately equal to Vₚ/Aₚ. This is the length of the pipette, and since most pipettes are about the same length, this term is relatively constant and can be ignored to a first order effect. Alternatively, −Vₚ, V_{dv}, and Aₚ could be entered via a keypad or other data entry method.

Referring again to FIG. 8, based on the relationships described above, the cross-sectional area Aₚ of the pipette may be determined based on a nozzle pressure drop ΔP (e.g., initial pressure Pᵢ minus final pressure P_{f}) within the air column of the pipette before and after the set aliquot volume V_{AQ} is dispensed from the pipette (e.g., with the pipette controller 10 of FIGS. 1 to 6 operating in the aliquot dispense mode):

ΔP=Pᵢ−P_{f}. (33)

The determined pressure drop ΔP correlates to a resulting height change Δh of the liquid column within the pipette:

Δh=hᵢ−h_{f}. (34)

The determined height change Δh of the liquid column within the pipette after the set aliquot volume V_{AQ} is dispensed from the pipette correlates to the cross-sectional area Aₚ of the pipette. Further, the determined cross-sectional area Aₚ of the pipette using equation (34) above correlates to an inner diameter D of the pipette. Thus, a pipette size (i.e., one of a plurality of predetermined pipette sizes, e.g., that are common in the industry) of the pipette can be inferred based on the determined inner diameter D of the pipette, as performed in Experiment #1 and Experiment #2 described below.

The data from Experiment #1 and Experiment #2 was collected by propping a pipette controller, such as, e.g., the pipette controller 10 of FIGS. 1 to 6, above a cup filled with a liquid. After connecting the aforementioned pipette controller to a computer, the pipette controller was flashed with code to print out the difference in nozzle pressure before and after dispensing of an aliquot. After that, a Python script was used to put the pipette controller in remote mode, through the “+R” serial command, to do remote multi-dispenses, through the “MD” command, to collect the pressure drop, and to store the data in a .txt file as a list of numbers with the form (a pipette size, a set aliquot volume, a nozzle pressure drop). After that, another Python script parsed the measurement data, plotted the nozzle pressure drop as a function of the set aliquot volume, and colored each data point with the color of the corresponding pipette size. Experiment #1 and Experiment #2 were conducted with this setup. Experiment #1 conducted ten (10) aliquots on each pipette size and the pipette was refilled only once the aspirated liquid was fully dispensed. Experiment #2 conducted ten (10) aliquots on each pipette size, but after each aliquot, the pipette was refilled to the same volume.

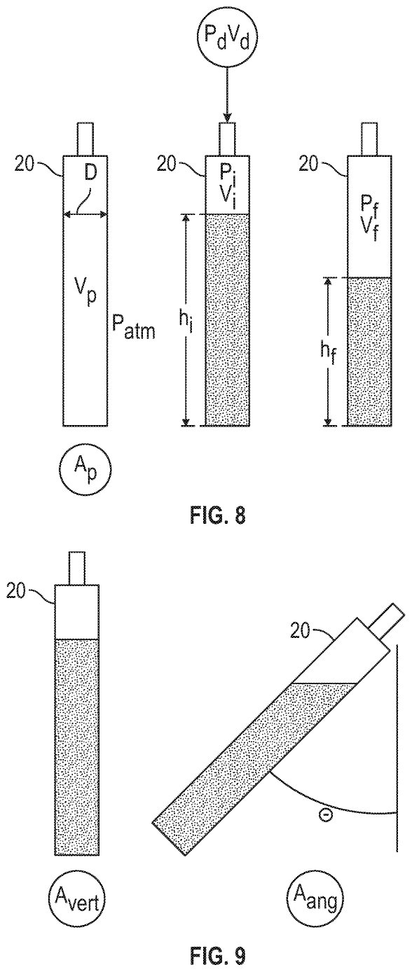

Experiment #1. FIG. 10 shows a graphical diagram of measurements which were conducted using five (5) pipettes (e.g., the pipette 20 of FIG. 1) of varying pipette sizes coupled to the pipette controller 10 of FIGS. 1 to 6. The pipettes utilized for the measurements had the following pipette sizes, a five (5) ml pipette, a ten (10) ml pipette, a twenty-five (25) ml pipette, a fifty (50) ml pipette, and a one hundred (100) ml pipette. The nozzle pressure drop ΔP (i.e., the initial pressure Pᵢ minus the final pressure P_{f}) was measured resulting from the following set aliquot volumes being dispensed from each of the pipettes, a one (1) ml set aliquot volume, a two (2) ml set aliquot volume, a three (3) ml set aliquot volume, a four (4) ml set aliquot volume, and a five (5) ml set aliquot volume.

For each of the pipettes, a maximum volume of liquid was aspirated into the pipette and then ten (10) aliquots were dispensed at each of the five (5) set aliquot volumes. In other words, in Experiment #1, the initial height of the liquid column within each pipette varied between each subsequent dispense of the set aliquot volume (i.e., liquid was not aspirated back into the pipette to a particular initial height of the liquid column before dispensing of the set aliquot volume).

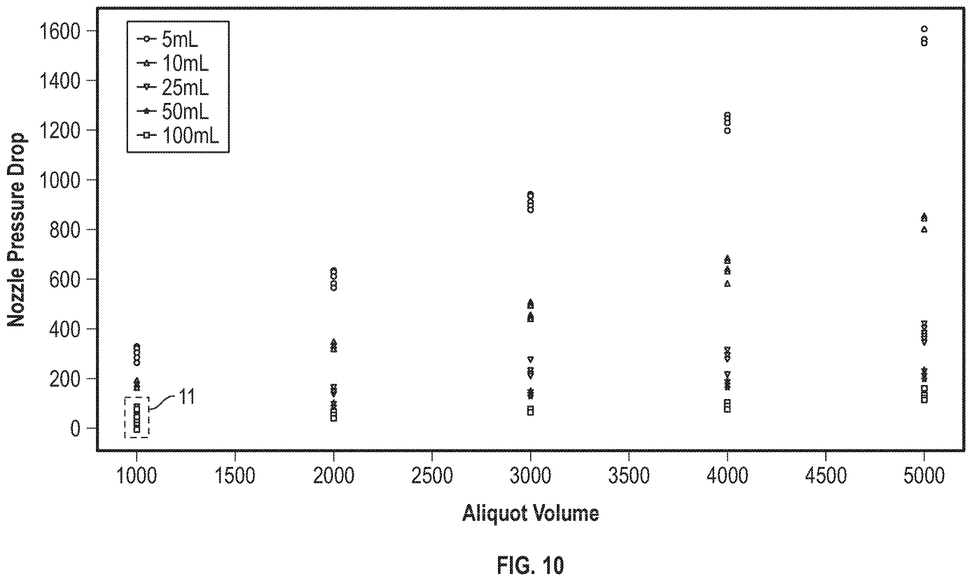

FIG. 11 shows a graphical diagram of the measurements of FIG. 10 for only the twenty-five (25) ml pipette, the fifty (50) ml pipette, and the one hundred (100) ml pipette at the set aliquot volume of one (1) ml. Table 1 below provides ranges of nozzle pressure drop ΔP obtained from measurement data of Experiment #1. In Experiment #1, and referring to Table 1 below, the difference in nozzle pressure drop ΔP between the five (5) ml pipet, the ten (10) ml pipet, and the twenty-five (25) ml pipette was apparent. For lower set aliquot volumes, however, the nozzle pressure drops of the twenty-five (25) ml pipet, the fifty (50) ml pipet, and the one hundred (100) ml pipette were difficult to distinguish from one another. Particularly, the spread between each aliquot was quite significant due to the aliquot having different starting points (i.e., initial liquid column height hᵢ (FIG. 8) within the pipette 20). Thus, in Experiment #1, the difference in pipette sizes (i.e., the nozzle pressure drop ΔP) became more apparent with more liquid being aliquoted.

TABLE 1

| | | Nozzle |
|---|---|---|
| Pipette | Set Aliquot | Pressure |
| Size (ml) | Volume (ml) | Drop (psi) |
| 5 | 1 | 225-325 |
| | 2 | 575-625 |
| | 3 | 875-925 |
| | 4 | 1150-1275 |
| | 5 | 1525-1625 |
| 10 | 1 | 160-200 |
| | 2 | 310-380 |
| | 3 | 410-520 |
| | 4 | 580-700 |
| | 5 | 780-840 |
| 25 | 1 | 62-84 |
| | 2 | 140-180 |
| | 3 | 190-260 |
| | 4 | 195-320 |
| | 5 | 325-415 |
| 50 | 1 | 38-52 |
| | 2 | 80-110 |
| | 3 | 115-150 |
| | 4 | 165-195 |
| | 5 | 195-215 |
| 100 | 1 | 15-38 |
| | 2 | 40-80 |
| | 3 | 75-90 |
| | 4 | 85-115 |
| | 5 | 105-175 |

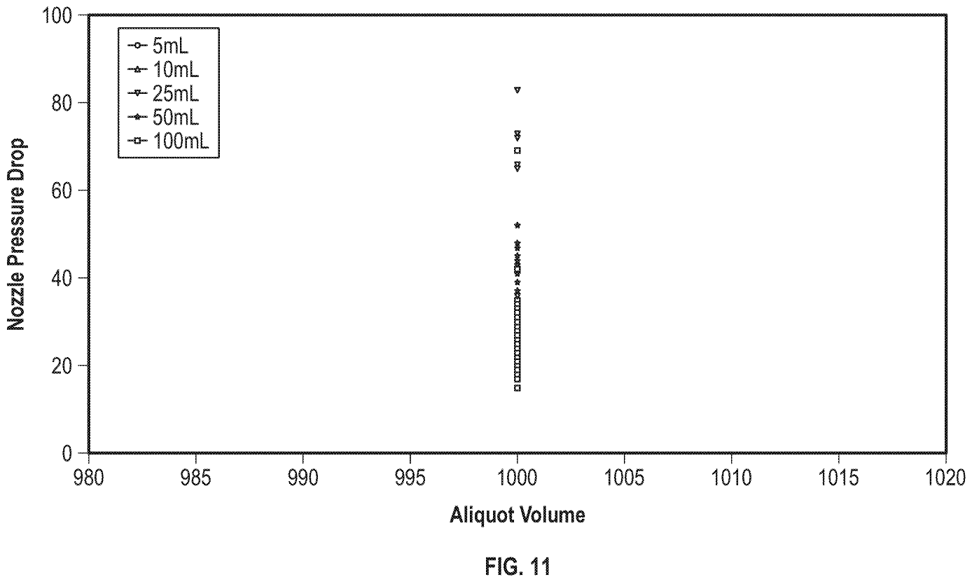

Experiment #2. FIG. 12 shows a graphical diagram of measurements which were conducted using five (5) pipettes (e.g., the pipette 20 of FIG. 1) of varying pipette sizes coupled to the pipette controller 10 of FIGS. 1 to 6. The pipettes utilized for the measurements had the following pipette sizes, a five (5) ml pipette, a ten (10) ml pipette, a twenty-five (25) ml pipette, a fifty (50) ml pipette, and a one hundred (100) ml pipette. The nozzle pressure drop ΔP (i.e., the initial pressure Pᵢ minus the final pressure P_{f}) was measured resulting from the following set aliquot volumes being dispensed from each of the pipettes, a one (1) ml set aliquot volume, a two (2) ml set aliquot volume, a three (3) ml set aliquot volume, a four (4) ml set aliquot volume, and a five (5) ml set aliquot volume.

For each of the pipettes, a particular volume of liquid was aspirated into the pipette and before one (1) of ten (10) aliquots were dispensed at each of the five (5) set aliquot volumes. In other words, in Experiment #2, the initial height of the liquid column hᵢ within each pipette was constant for each dispense of the set aliquot volume (i.e., liquid was aspirated back into the pipette to a particular initial liquid column height hᵢ before dispensing of the set aliquot volume).

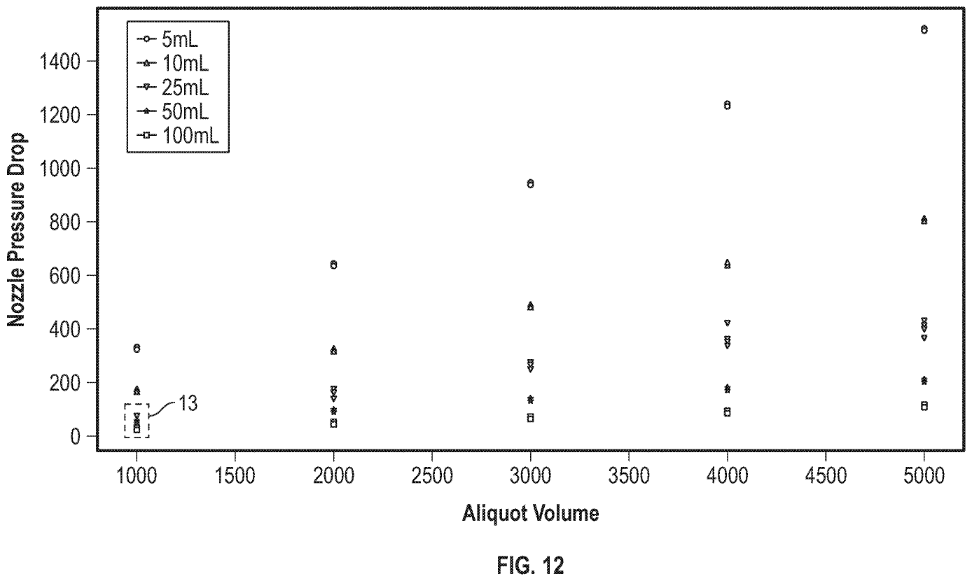

FIG. 13 shows a graphical diagram of the measurements of FIG. 12 for only the twenty-five (25) ml pipette, the fifty (50) ml pipette, and the one hundred (100) ml pipette at the set aliquot volume of one (1) ml. Table 2 below provides ranges of nozzle pressure drops obtained from measurement data of Experiment #2. In Experiment #2, and referring to Table 2 below, there was a significantly narrower spread in nozzle pressure drop ΔP, as compared to Experiment #1, as a result of starting each aliquot at the same initial volume (i.e., initial liquid column height hᵢ). This was very apparent when comparing FIGS. 10 and 12. The data points of FIG. 10 blend together much more, while the data points of FIG. 12 are more separated. Similar to Experiment #1, in Experiment #2, the difference in pipette sizes becomes more apparent with more liquid aliquoted.

TABLE 2

| | | Nozzle |
|---|---|---|
| Pipette | Set Aliquot | Pressure |
| Size (ml) | Volume (ml) | Drop (psi) |
| 5 | 1 | 320-360 |
| | 2 | 620-650 |
| | 3 | 960-980 |
| | 4 | 1210-1240 |
| | 5 | 1460-1490 |
| 10 | 1 | 180-195 |
| | 2 | 310-350 |
| | 3 | 460-480 |
| | 4 | 610-640 |
| | 5 | 790-810 |
| 25 | 1 | 68-78 |
| | 2 | 150-195 |
| | 3 | 220-270 |
| | 4 | 310-420 |
| | 5 | 360-435 |
| 50 | 1 | 46-56 |
| | 2 | 80-95 |
| | 3 | 120-140 |
| | 4 | 175-195 |
| | 5 | 195-215 |
| 100 | 1 | 18-32 |
| | 2 | 40-60 |
| | 3 | 58-70 |
| | 4 | 70-82 |
| | 5 | 82-100 |

Referring again to FIGS. 1 to 6, in some embodiments, the pipette controller 10 can be configured to determine a pipette size of the pipette 20 that is removably coupled to the nozzle assembly 18. Particularly, the controller 42 of the pipette controller 10 can be configured to determine a pipette size of the pipette 20 based on a pressure change resulting from an aliquot of liquid being dispensed from the pipette 20. For example, the controller 42 can be configured to measure, via the nozzle pressure sensor 40, an initial nozzle pressure before the aliquot of liquid is dispensed from the pipette 20 and a final nozzle pressure subsequent to the aliquot of liquid being dispensed from the pipette 20. The difference between the initial nozzle pressure and the final nozzle pressure corresponds to a nozzle pressure drop within the pipette 20.

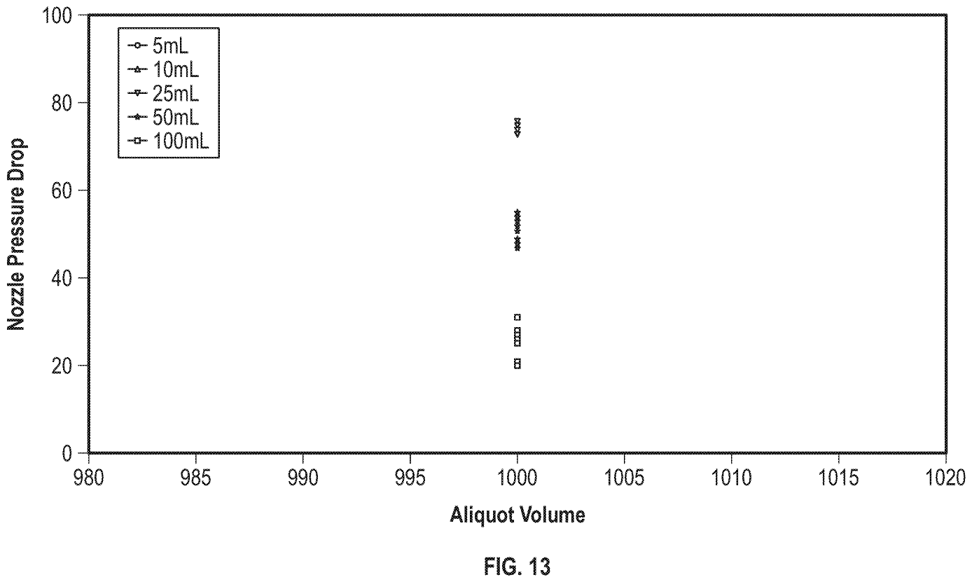

FIG. 14 illustrates a flowchart 200 of another exemplary aliquot dispense mode of the pipette controller 10 of FIGS. 1 to 6. As shown in flowchart 200, with the pipette controller 10 operating in the aliquot dispense mode, the set aliquot volume is determined via the interface sensor 98. When the aliquot switch 94 is actuated, which communicates to the controller 42 that an aliquot is desired, the controller 42 reads the nozzle pressure sensor 40 to determine an initial nozzle pressure Pᵢ within the pipette 20 (FIG. 1) and then opens the aliquot valve 82 to dispense the set aliquot volume. Once the set aliquot volume is dispensed (e.g., as determined by the controller 42), the controller 42 closes the aliquot valve 82 and reads the nozzle pressure sensor 40 to determine a final nozzle pressure P_{f} within the pipette 20. The controller 42 then calculates a nozzle pressure drop ΔP based on the initial nozzle pressure Pᵢ and the final nozzle pressure P_{f}. If the calculated nozzle pressure drop ΔP is within a predetermined range of nozzle pressure drops of a plurality of predetermined ranges of nozzle pressure drops (e.g., as stored in a memory (not shown) of the controller 42), the set pipette size of the pipette controller 10 (e.g., as stored in the controller 42) is set (e.g., maintained or changed) based on determined pipette size of the pipette 20. If the calculated nozzle pressure drop ΔP does not fall within a predetermined range of nozzle pressure drops of the plurality of predetermined ranges of nozzle pressure drops (or falls within two or more predetermined ranges of nozzle pressure drops of the plurality of predetermined ranges of nozzle pressure drops), the process is repeated until a calculated nozzle pressure drop ΔP falls within one predetermined range of nozzle pressure drops of the plurality of predetermined ranges of nozzle pressure drops.

In some embodiments, the plurality of predetermined ranges of nozzle pressure drops can be based experimental data of the pipette controller 10, e.g., data from Experiment #1 and/or Experiment #2, and the set aliquot volume. For example, in some such embodiments, a first predetermined range of nozzle pressures can correspond to a pipette size of five (5) ml and set aliquot volumes of one (1) ml, two (2) ml, three (3) ml, four (4) ml, and five (5) ml, and a second predetermined range of nozzle pressures can correspond to a pipette size of ten (10) ml and set aliquot volumes of one (1) ml, two (2) ml, three (3) ml, four (4) ml, and five (5) ml. A third predetermined range of nozzle pressures can correspond to a pipette size of twenty-five (25) ml and set aliquot volumes of one (1) ml, two (2) ml, three (3) ml, four (4) ml, and five (5) ml, and a fourth predetermined range of nozzle pressures can correspond to a pipette size of fifty (50) ml and set aliquot volumes of one (1) ml, two (2) ml, three (3) ml, four (4) ml, and five (5) ml. In some embodiments, a fifth predetermined range of nozzle pressures can correspond to a pipette size of one hundred (100) ml and set aliquot volumes of one (1) ml, two (2) ml, three (3) ml, four (4) ml, and five (5) ml.

In some embodiments, the plurality of predetermined ranges of nozzle pressure drops can be stored in a memory (not shown) of the controller 42. In some embodiments, the plurality of predetermined ranges of nozzle pressure drops can be set by a user. In some embodiments, the controller 42 may be configured to determine the plurality of predetermined ranges of nozzle pressure drops based on continued operation of the pipette controller 10. For example, in some embodiments, the controller 42 may utilize a predictive algorithm to determine the plurality of predetermined ranges of nozzle pressure drops based prior operation of the pipette controller 10 with user entered pipette sizes.

In some embodiments, the controller 42 can be configured to default to an initial set pipette size that is one of five (5) ml, ten (10) ml, twenty-five (25) ml, fifty (50) ml, or one hundred (100) ml. In some embodiments, the controller 42 can be configured to default to an initial set pipette size that is one of ten (10) ml, twenty-five (25) ml, or fifty (50) ml. In some embodiments, the controller 42 can be configured to default to an initial set pipette size that is twenty-five (25) ml. In some embodiments, the controller 42 can be configured to default to an initial set pipette size once the pipette controller is initially turned to an operating mode from a standby mode. In some embodiments, the controller 42 can be configured to default to an initial set pipette size once the pipette controller 10 is in a standby mode for a predetermined amount of time. In some embodiments, the pipette controller 10 can include a pipette sensor (not shown) that is configured to sense if the pipette 20 (FIG. 1) is removably coupled to the nozzle assembly 18. In some such embodiments, the controller 42 can be configured to default to an initial set pipette size based on signals from the pipette sensor (not shown).

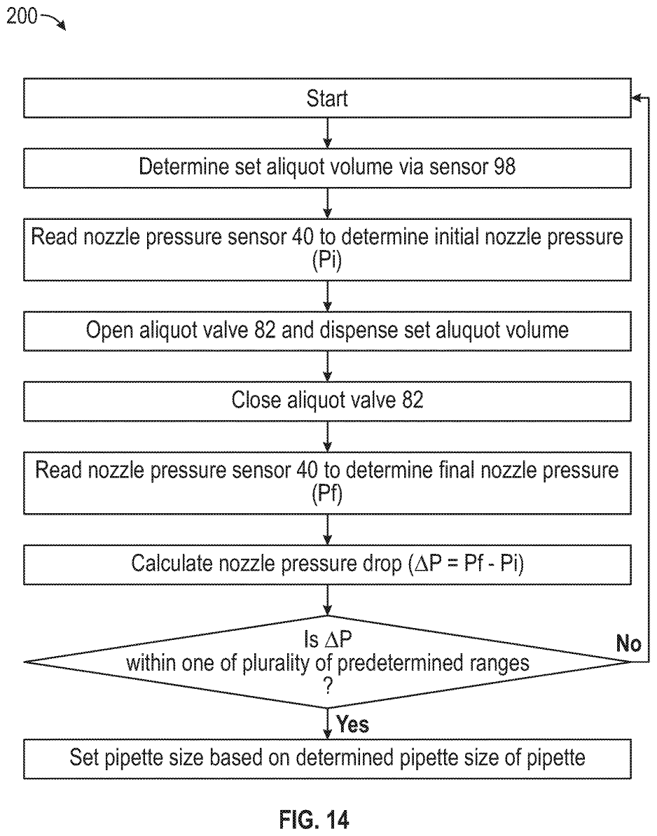

FIG. 15 is a flowchart depicting a method 300 of determining a pipette size of a pipette coupled to a pipette controller, according to the present disclosure. While reference is made to the pipette controller 10 of FIGS. 1 to 6, the method 300 can be utilized with any type of apparatus that aspirates and dispenses a liquid.

As shown in FIG. 15, the method 300 includes, in step 310, aspirating a volume of liquid into the pipette coupled to the pipette controller, and, in step 320, measuring an initial nozzle pressure of an initial air column within the pipette coupled to the pipette controller. For example, with reference to the pipette controller 10 illustrated in FIGS. 1 to 6, step 310 can include, operating the pipette controller 10 in the manual aspirate mode to draw a liquid into the pipette 20 (FIG. 1), and step 320 can include measuring an initial nozzle pressure within the pipette 20 via signals received from the nozzle pressure sensor 40 by the controller 42.

Referring still to FIG. 15, the method 300 further includes, in step 330, dispensing a set aliquot volume of liquid from the pipette coupled to the pipette controller and, in step 340, measuring a final nozzle pressure of a final air column within the pipette coupled to the pipette controller. For example, with reference again to the pipette controller 10 illustrated in FIGS. 1 to 6, step 330 can include opening the aliquot valve 82 until the set aliquot volume, as set by the aliquot volume control interface 30, is dispensed from the pipette 20 (FIG. 1), and step 340 can include measuring a final nozzle pressure within the pipette 20 via signals received from the nozzle pressure sensor 40 by the controller 42.

The method 300 further includes, in step 350, calculating a nozzle pressure drop from the measured initial nozzle pressure, as in step 320, and the measured final nozzle pressure, as in step 340, of the pipette coupled to the pipette controller. For example, with reference again to the pipette controller 10 illustrated in FIGS. 1 to 6, step 350 can include calculating, via the controller 42, a nozzle pressure drop within the pipette 20 (FIG. 1) based on the measured initial nozzle pressure and the measured final nozzle pressure of the pipette 20.

With continued reference to FIG. 15, the method 300 further includes, in step 360, determining a pipette size of the pipette coupled to the pipette controller based on the calculated nozzle pressure drop, as in step 350. For example, with reference again to the pipette controller 10 illustrated in FIGS. 1 to 6, step 360 can include determining, via the controller 42, the pipette size of the pipette 20 (FIG. 1) based on the calculated nozzle pressure drop within the pipette 20.

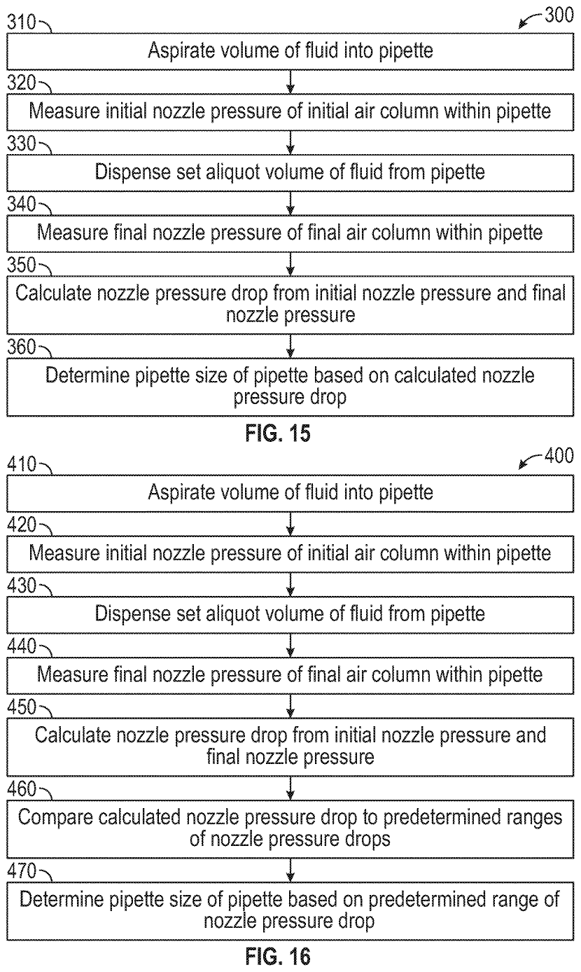

FIG. 16 is a flowchart depicting a method 400 of determining a pipette size of a pipette coupled to a pipette controller, according to the present disclosure. While reference is made to the pipette controller 10 of FIGS. 1 to 6, the method 400 can be utilized with any type of apparatus that aspirates and dispenses a liquid.

As shown in FIG. 16, the method 400 includes, in step 410, aspirating a volume of liquid into the pipette coupled to the pipette controller, and, in step 420, measuring an initial nozzle pressure of an initial air column within the pipette coupled to the pipette controller. For example, with reference to the pipette controller 10 illustrated in FIGS. 1 to 6, step 410 can include, operating the pipette controller 10 in the manual aspirate mode to draw a liquid into the pipette 20 (FIG. 1), and step 420 can include measuring an initial nozzle pressure within the pipette 20 via signals received from the nozzle pressure sensor 40 by the controller 42.

The method 400 further includes, in step 430, dispensing a set aliquot volume of liquid from the pipette coupled to the pipette controller and, in step 440, measuring a final nozzle pressure of a final air column within the pipette coupled to the pipette controller. For example, with reference again to the pipette controller 10 illustrated in FIGS. 1 to 6, step 430 can include opening the aliquot valve 82 until the set aliquot volume, as set by the aliquot volume control interface 30, is dispensed from the pipette 20 (FIG. 1), and step 440 can include measuring a final nozzle pressure within the pipette 20 via signals received from the nozzle pressure sensor 40 by the controller 42.

Referring still to FIG. 16, the method 400 further includes, in step 450, calculating a nozzle pressure drop from the measured initial nozzle pressure, as in step 420, and the measured final nozzle pressure, as in step 440, of the pipette coupled to the pipette controller. For example, with reference again to the pipette controller 10 illustrated in FIGS. 1 to 6, step 450 can include calculating, via the controller 42, a nozzle pressure drop within the pipette 20 (FIG. 1) based on the measured initial nozzle pressure and the measured final nozzle pressure of the pipette 20.

The method 400 further includes, in step 460, comparing the calculated nozzle pressure drop a plurality of predetermined ranges of nozzle pressure drops and, in step 470, determining a pipette size of the pipette based on the calculated nozzle pressure drop and the plurality of predetermined ranges of nozzle pressure drops. For example, with reference again to the pipette controller 10 illustrated in FIGS. 1 to 6, step 460 can include comparing, via the controller 42, the calculated nozzle pressure drop to a plurality of predetermined ranges of nozzle pressure drops stored in a memory (not shown) of the controller 42, and step 470 can include determining, via the controller 42, the pipette size of the pipette 20 (FIG. 1) when the calculated nozzle pressure drop falls within one or more predetermined ranges of nozzle pressure drops of the plurality of predetermined ranges of nozzle pressure drops.

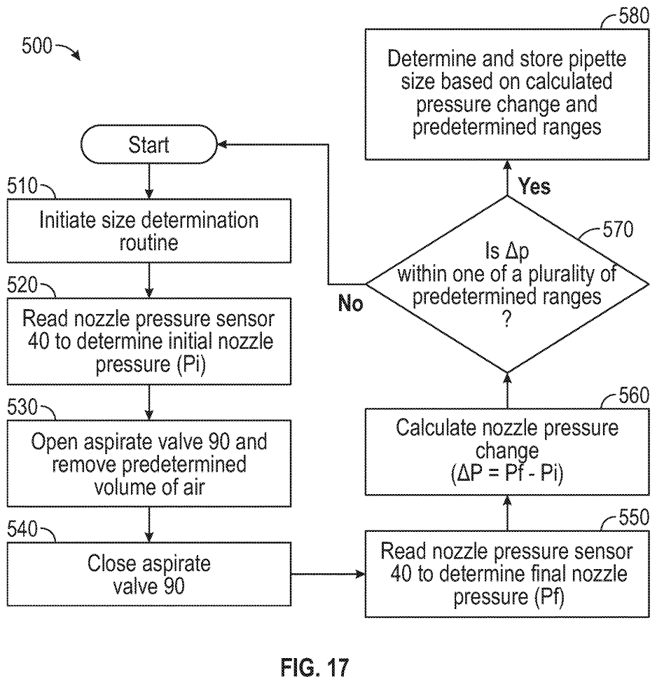

FIG. 17 is a flowchart depicting a method 500 of determining a pipette size of a pipette coupled to a pipette controller, according to the present disclosure. While reference is made to the pipette controller 10 of FIGS. 1 to 6, the method 500 can be utilized with any type of apparatus that aspirates and dispenses a liquid. In some embodiments, the method 500 is initiated when a pipette, such as the pipette 20 of FIG. 1, is first coupled to the nozzle assembly 18 of the pipette controller 10, and the determined pipette size is stored by the controller 42 for use during subsequent operation of the pipette controller 10 until the pipette 20 is decoupled from the nozzle assembly 18.

As shown in FIG. 17, the method 500 includes, in step 510, initiating a pipette size determination routine via the pipette controller 10. In some embodiments, step 510 includes actuating a detection actuator (not shown) of the pipette controller 10 operable by a user to initiate the pipette size determination routine. In some embodiments, the pipette controller 10 includes a pipette presence sensor (not shown) configured to detect when the pipette 20 is removably coupled to the nozzle assembly 18, and step 510 includes the controller 42 automatically initiating the pipette size determination routine upon the pipette presence sensor detecting coupling of the pipette 20 to the nozzle assembly 18. The method 500 further includes, in step 520, measuring an initial nozzle pressure Pi of an initial air column within the pipette 20 coupled to the pipette controller 10. For example, with reference to the pipette controller 10 illustrated in FIGS. 1 to 6, step 520 can include measuring an initial nozzle pressure Pi within the pipette 20 via signals received from the nozzle pressure sensor 40 by the controller 42.

With continued reference to FIG. 17, the method 500 further includes, in step 530, removing a predetermined volume of air from the pipette 20 via the pipette controller 10, and, in step 540, closing the aspirate valve 90 of the pipette controller 10 upon removal of the predetermined volume of air. In the illustrated embodiment, step 530 includes opening the aspirate valve 90 to apply a vacuum from the vacuum tank 62 to the manifold 32 and from there to the pipette 20 via the nozzle assembly 18, thereby drawing the predetermined volume of air from the pipette 20 into the vacuum tank 62. In some embodiments, step 530 may alternatively include operating the pump 46 of the pipette controller 10 to draw the predetermined volume of air from the pipette 20. In some embodiments, step 530 may include operating another air displacement mechanism of the pipette controller 10 configured to remove a predetermined volume of air from the pipette 20. In some such embodiments, the predetermined volume of air removed from the pipette 20 in step 530 corresponds to a known quantity sufficient to produce a distinguishable pressure change within the pipette 20 for each of a plurality of pipette sizes, as discussed in greater detail below with respect to steps 560 and 570.

The method 500 further includes, in step 550, measuring a final nozzle pressure Pf of a final air column within the pipette 20 after the predetermined volume of air has been removed from the pipette 20 in step 530 and the aspirate valve 90 has been closed in step 540. For example, with reference to the pipette controller 10 illustrated in FIGS. 1 to 6, step 550 can include measuring a final nozzle pressure Pf within the pipette 20 via signals received from the nozzle pressure sensor 40 by the controller 42.

The method 500 further includes, in step 560, calculating a nozzle pressure change ΔP from the measured initial nozzle pressure Pi, as in step 520, and the measured final nozzle pressure Pf, as in step 550, of the pipette 20 coupled to the pipette controller 10. For example, with reference to the pipette controller 10 illustrated in FIGS. 1 to 6, step 560 can include calculating, via the controller 42, a nozzle pressure change ΔP within the pipette 20 based on the measured initial nozzle pressure Pi and the measured final nozzle pressure Pf of the pipette 20, as expressed by equation (33) above. As discussed above with respect to the pipette controller 10 of FIGS. 1 to 6, the determined pressure change ΔP correlates to a resulting height change Δh of the liquid column within the pipette 20, which in turn correlates to the cross-sectional area Ap of the pipette 20 and thus to the inner diameter D and pipette size of the pipette 20. Accordingly, the nozzle pressure change ΔP resulting from the removal of a predetermined volume of air from the pipette 20 in step 530 provides a basis for determining the pipette size of the pipette 20 in steps 570 and 580 below.

With continued reference to FIG. 17, the method 500 further includes, in step 570, comparing the calculated nozzle pressure change ΔP to a plurality of predetermined ranges of nozzle pressure changes corresponding to a plurality of pipette sizes. For example, with reference to the pipette controller 10 illustrated in FIGS. 1 to 6, step 570 can include comparing, via the controller 42, the calculated nozzle pressure change ΔP to a plurality of predetermined ranges of nozzle pressure changes stored in a memory (not shown) of the controller 42. If the calculated nozzle pressure change ΔP falls within one of the plurality of predetermined ranges of nozzle pressure changes, the method 500 proceeds to step 580. If the calculated nozzle pressure change ΔP does not fall within one of the plurality of predetermined ranges of nozzle pressure changes, the method 500 returns to step 510 and the method 500 may indicate to the user that no pipette size was determined, and in some embodiments the pipette size determination routine may be re-initiated automatically or upon user input. The method 500 further includes, in step 580, determining and storing, via the controller 42, the pipette size of the pipette 20 based on the calculated nozzle pressure change ΔP and the plurality of predetermined ranges of nozzle pressure changes. In some embodiments, the controller 42 is further configured to clear the stored pipette size upon a pipette presence sensor (not shown) of the pipette controller 10 detecting decoupling of the pipette 20 from the nozzle assembly 18, such that the pipette size determination routine of method 500 is re-initiated upon coupling of a subsequent pipette to the nozzle assembly 18.

Accordingly, the present disclosure provides for a pipette controller that can determine a particular pipette size of a pipette coupled to the pipette controller based on a nozzle pressure drop within the pipette after a set aliquot volume is dispensed from the pipette. Particularly, embodiments of the present disclosure utilize a nozzle pressure sensor built into a pipette controller to measure a change in static pressure before and after dispensing a known volume of liquid from the pipette. This equates to the change in the height of the liquid column for a given volume and therefor deduces the diameter (corresponding to volume capacity) of the installed pipette. Thus, embodiments of the present disclosure can provide for automatic aliquoting and aspirating of the pipette controller, as well as automatic filling of the pipette (e.g., to a maximum volume of the particular pipette) for subsequent repeat aliquoting. Embodiments of the present disclosure can prevent over-aspiration of liquid into the pipette controller thereby increasing reliability. Embodiments of the present disclosure can also improve the accuracy and precision of the dispensed volumes from the pipette controller by compensating for the pipette size (e.g., a pipette diameter).

Further aspects are provided by the subject matter of the following clauses.

A pipette controller includes a nozzle assembly, a pipette removably coupled to the nozzle assembly, a pressure tank pneumatically connected to the nozzle assembly, a pump pneumatically connected to the pressure tank and configured to inject air into the pressure tank to create positive air pressure inside the pressure tank, an aliquot valve controlling airflow between the pressure tank and the nozzle assembly, and an electronic controller in electrical communication with the aliquot valve. The electronic controller is configured to control the aliquot valve to dispense a volume of liquid equal to a set aliquot volume from the pipette via an amount of air transferred from the pressure tank to the nozzle assembly and determine a pipette size of the pipette based on a pressure drop of an air pressure within the pipette resulting from the volume of liquid equal to the set aliquot volume being dispensed from the pipette.

The pipette controller of the preceding clause, further including a nozzle pressure sensor in electrical communication with the electronic controller and arranged to sense an air pressure within the pipette.

The pipette controller of any preceding clause, further including an aliquot volume control interface in electrical communication with the electronic controller and being configured to receive a user input corresponding to the set aliquot volume.

The pipette controller of any preceding clause, further including a vacuum tank pneumatically connected to the nozzle assembly.

The pipette controller of any preceding clause, the electronic controller being further configured to measure an initial air pressure within the pipette before the set aliquot volume of the liquid is dispensed from the pipette, measure a final air pressure within the pipette after the set aliquot volume of the liquid is dispensed from the pipette, and compare the initial air pressure and the final air pressure to determine the pressure drop within the pipette.

The pipette controller of any preceding clause, the electronic controller being further configured to compare the pressure drop to a plurality of predetermined ranges of pressure drops corresponding to a plurality of pipette sizes and a plurality of set aliquot volumes.

The pipette controller of any preceding clause, the plurality of predetermined ranges of pressure drops being stored in a memory of the electronic controller.

The pipette controller of any preceding clause, the electronic controller being further configured to produce the plurality of predetermined ranges of pressure drops based on prior operation of the pipette controller.

The pipette controller of any preceding clause, the plurality of pipette sizes including one (1) milliliter (ml), five (5) ml, ten (10) ml, twenty-five (25) ml, fifty (50) ml, and one hundred (100) ml.

The pipette controller of any preceding clause, further comprising: a detection actuator operable by a user to initiate a pipette size determination routine; and a pipette presence sensor configured to detect when the pipette is removably coupled to and decoupled from the nozzle assembly.

The pipette controller of any preceding clause, wherein the electronic controller is further configured to store the determined pipette size upon completion of the pipette size determination routine and to clear the stored pipette size upon the pipette presence sensor detecting decoupling of the pipette from the nozzle assembly.

A method of determining a pipette size of a pipette coupled to a pipette controller includes aspirating a volume of liquid into the pipette via the pipette controller, dispensing a set aliquot volume of the liquid from the pipette via the pipette controller, calculating a pressure drop of an air pressure within the pipette resulting from the dispensing of the set aliquot volume of the liquid from the pipette, and determining the pipette size of the pipette based on the calculated pressure drop.

The method of the preceding clause, the pipette size is one of one (1) milliliter (ml), five (5) ml, ten (10) ml, twenty-five (25) ml, fifty (50) ml, or one hundred (100) ml.

The method of any preceding clause, the set aliquot volume being one of a plurality of set aliquot volumes that is selectable by a user, the plurality of set aliquot volumes being in a range of about 1.0 milliliter (ml) to about 20 ml or in a range of about 1.0 ml to about 10 ml.

The method of any preceding clause, wherein calculating the pressure drop of the air pressure within the pipette includes measuring an initial air pressure within the pipette before the set aliquot volume of the liquid is dispensed from the pipette via the pipette controller, measuring a final air pressure within the pipette after the set aliquot volume of the liquid is dispensed from the pipette via the pipette controller, and comparing the initial air pressure and the final air pressure.

The method of any preceding clause, wherein determining the pipette size of the pipette includes comparing the calculated pressure drop to a plurality of predetermined ranges of pressure drops corresponding to a plurality of pipette sizes and a plurality of set aliquot volumes.

The method of any preceding clause, the plurality of pipette sizes including five (5) ml, ten (10) ml, twenty-five (25) ml, fifty (50) ml, and one hundred (100) ml.

The method of any preceding clause, the plurality of set aliquot volumes being in a range of about 1.0 milliliter (ml) to about 20 ml or in a range of about 1.0 ml to about 10 ml.

The method of any preceding clause, the plurality of predetermined ranges of pressure drops are stored in a memory of the pipette controller.

The method of any preceding clause, a controller of the pipette controller being configured to receive user inputs corresponding to the plurality of predetermined ranges of pressure drops.

The method of any preceding clause, a controller of the pipette controller being configured to produce the plurality of predetermined ranges of pressure drops based on operation of the pipette controller.

A method of determining a pipette size of a pipette coupled to a pipette controller, the method including initiating a pipette size determination routine via the pipette controller, measuring an initial air pressure within the pipette via the pipette controller, removing a predetermined volume of air from the pipette via the pipette controller, measuring a resulting air pressure within the pipette after removing the predetermined volume of air, calculating a pressure change from the initial air pressure to the resulting air pressure, comparing the calculated pressure change to a plurality of predetermined ranges of pressure changes corresponding to a plurality of pipette sizes, and determining and storing the pipette size of the pipette based on the comparison.

The method of the preceding clause, wherein removing the predetermined volume of air from the pipette comprises one of: applying a vacuum from a vacuum tank of the pipette controller to the pipette, operating a pump of the pipette controller to draw air from the pipette, or any other mechanism configured to remove a predetermined volume of air from the pipette.

The method of any preceding clause, wherein the plurality of pipette sizes includes a five (5) milliliter (ml) pipette, a ten (10) ml pipette, a twenty-five (25) ml pipette, a fifty (50) ml pipette, and a one hundred (100) ml pipette.

The method of any preceding clause, wherein the pipette controller further comprises a pipette presence sensor configured to detect decoupling of the pipette from the pipette controller, and wherein the method further comprises clearing the stored pipette size upon the pipette presence sensor detecting decoupling of the pipette from the pipette controller.

The method of any preceding clause, wherein initiating the pipette size determination routine comprises actuating a detection actuator of the pipette controller.

A pipette controller includes a nozzle assembly configured to removably couple a pipette to the pipette controller, a pressure tank pneumatically connected to the nozzle assembly, a pump pneumatically connected to the pressure tank and configured to create positive air pressure inside the pressure tank, an aliquot valve controlling airflow between the pressure tank and the nozzle assembly, and an electronic controller in electrical communication with the aliquot valve. The electronic controller is configured to control the aliquot valve to dispense a volume of liquid equal to a set aliquot volume from the pipette via an amount of air transferred from the pressure tank to the nozzle assembly and to determine a pipette size of the pipette based on a pressure drop of an air pressure within the pipette resulting from the volume of liquid equal to the set aliquot volume being dispensed from the pipette. The pipette controller is further configured to determine the pipette size via a pipette size determination routine in which a predetermined volume of air is removed from the pipette and a resulting pressure change is compared to predetermined ranges corresponding to a plurality of pipette sizes.

Although the foregoing description is directed to some embodiments of the present disclosure, other variations and modifications will be apparent to those skilled in the art and may be made without departing from the spirit and the scope of the present disclosure. While certain embodiments reference pipette sizes of five (5) ml, ten (10) ml, twenty-five (25) ml, fifty (50) ml, and one hundred (100) ml, the present disclosure is not limited to these sizes, and the methods and devices described herein are applicable to any pipette size for which predetermined pressure change ranges can be established. Moreover, features described in connection with one embodiment of the present disclosure may be used in conjunction with other embodiments, even if not explicitly stated above.

1. A pipette controller comprising:
a nozzle assembly;
a pipette removably coupled to the nozzle assembly;
a pressure tank pneumatically connected to the nozzle assembly;
a pump pneumatically connected to the pressure tank and configured to inject air into the pressure tank to create positive air pressure inside the pressure tank;
an aliquot valve controlling airflow between the pressure tank and the nozzle assembly; and
an electronic controller in electrical communication with the aliquot valve, the electronic controller being configured:
to control the aliquot valve to dispense a volume of liquid equal to a set aliquot volume from the pipette via an amount of air transferred from the pressure tank to the nozzle assembly; and
to determine a pipette size of the pipette based on a pressure drop of an air pressure within the pipette resulting from the volume of liquid equal to the set aliquot volume being dispensed from the pipette.

2. The pipette controller of claim 1, further comprising an aliquot volume control interface in electrical communication with the electronic controller and being configured to receive a user input corresponding to the set aliquot volume.

3. The pipette controller of claim 1, wherein the electronic controller is further configured:
to measure an initial air pressure within the pipette before the set aliquot volume of the liquid is dispensed from the pipette;
to measure a final air pressure within the pipette after the set aliquot volume of the liquid is dispensed from the pipette; and
to compare the initial air pressure and the final air pressure to determine the pressure drop within the pipette.

4. The pipette controller of claim 1, wherein the pressure tank is pneumatically connected to the nozzle assembly via a manifold.

5. The pipette controller of claim 4, further comprising a vacuum tank pneumatically connected to the nozzle assembly via the manifold.

6. The pipette controller of claim 1, further comprising a nozzle pressure sensor in electrical communication with the electronic controller and arranged to sense an air pressure within the pipette.

7. The pipette controller of claim 6, wherein the nozzle pressure sensor is arranged to sense an air pressure at a manifold in fluid communication with the nozzle assembly.

8. The pipette controller of claim 1, wherein the electronic controller is further configured to compare the pressure drop to a plurality of predetermined ranges of pressure drops corresponding to a plurality of pipette sizes and a plurality of set aliquot volumes.

9. The pipette controller of claim 8, wherein the plurality of pipette sizes includes a five (5) milliliter (ml) pipette, a ten (10) ml pipette, a twenty-five (25) ml pipette, a fifty (50) ml pipette, and a one hundred (100) ml pipette.

10. The pipette controller of claim 1, further comprising: a detection actuator operable by a user to initiate a pipette size determination routine; and a pipette presence sensor configured to detect when the pipette is removably coupled to and decoupled from the nozzle assembly.

11. The pipette controller of claim 10, wherein the electronic controller is further configured to store the determined pipette size upon completion of the pipette size determination routine and to clear the stored pipette size upon the pipette presence sensor detecting decoupling of the pipette from the nozzle assembly.

12. A method of determining a pipette size of a pipette coupled to a pipette controller, the method comprising:
aspirating a volume of liquid into the pipette via the pipette controller;
dispensing a set aliquot volume of the liquid from the pipette via the pipette controller;
calculating a pressure drop of an air pressure within the pipette resulting from the dispensing of the set aliquot volume of the liquid from the pipette; and
determining the pipette size of the pipette based on the calculated pressure drop.

13. The method of claim 12, wherein calculating the pressure drop of the air pressure within the pipette includes:
measuring an initial air pressure within the pipette before the set aliquot volume of the liquid is dispensed from the pipette via the pipette controller;
measuring a final air pressure within the pipette after the set aliquot volume of the liquid is dispensed from the pipette via the pipette controller; and
comparing the initial air pressure and the final air pressure.

14. The method of claim 12, wherein the pipette size of the pipette is one of five (5) milliliters (ml), ten (10) ml, twenty-five (25) ml, fifty (50) ml, or one hundred (100) ml.

15. The method of claim 12, wherein the set aliquot volume is one of a plurality of set aliquot volumes that is selectable by a user, the plurality of set aliquot volumes being in a range of about 1.0 milliliter (ml) to about 20 ml.

16. The method of claim 12, wherein determining the pipette size of the pipette includes comparing the calculated pressure drop to a plurality of predetermined ranges of pressure drops corresponding to a plurality of pipette sizes and a plurality of set aliquot volumes.

17. The method of claim 16, wherein the plurality of pipette sizes includes a five (5) milliliter (ml) pipette, a ten (10) ml pipette, a twenty-five (25) ml pipette, a fifty (50) ml pipette, and a one hundred (100) ml pipette.

18. The method of claim 16, wherein the plurality of predetermined ranges of pressure drops are stored in a memory of the pipette controller.

19. A method of determining a pipette size of a pipette coupled to a pipette controller, the method comprising:
initiating a pipette size determination routine via the pipette controller;
measuring an initial air pressure within the pipette via the pipette controller;
removing a predetermined volume of air from the pipette via the pipette controller;
measuring a resulting air pressure within the pipette after removing the predetermined volume of air;
calculating a pressure change from the initial air pressure to the resulting air pressure;
comparing the calculated pressure change to a plurality of predetermined ranges of pressure changes corresponding to a plurality of pipette sizes; and
determining and storing the pipette size of the pipette based on the comparison.

20. The method of claim 19, wherein removing the predetermined volume of air from the pipette comprises one of: applying a vacuum from a vacuum tank of the pipette controller to the pipette, operating a pump of the pipette controller to draw air from the pipette, or any other mechanism configured to remove a predetermined volume of air from the pipette.

21. The method of claim 19, wherein the plurality of pipette sizes includes a five (5) milliliter (ml) pipette, a ten (10) ml pipette, a twenty-five (25) ml pipette, a fifty (50) ml pipette, and a one hundred (100) ml pipette.

22. The method of claim 19, wherein the pipette controller further comprises a pipette presence sensor configured to detect decoupling of the pipette from the pipette controller, and wherein the method further comprises clearing the stored pipette size upon the pipette presence sensor detecting decoupling of the pipette from the pipette controller.

23. The method of claim 19, wherein initiating the pipette size determination routine comprises actuating a detection actuator of the pipette controller.
